(19) United States
(12) Patent Application Publication
(10) Pub. No.: US 2026/0032232 A1
(43) Pub. Date: Jan. 29, 2026

(54) ENCODING METHOD, DECODING METHOD, CODE STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Lai ZHANG, Dongguan (CN); Fan WANG, Dongguan (CN)

(73) Assignee: GUANGDONG OPPO MOBILE TELECOMMUNICATIONS CORP., LTD., Dongguan (CN)

(21) Appl. No.: 19/343,204

(22) Filed: Sep. 29, 2025

Related U.S. Application Data
(63) Continuation of application No. PCT/CN2023/085280, filed on Mar. 30, 2023.

(51) Int. Cl. H04N 19/105; H04N 19/159; H04N 19/176

(52) U.S. Cl. CPC H04N 19/105; H04N 19/159; H04N 19/176

(57) ABSTRACT

Disclosed in embodiments of the present application are an encoding method, a decoding method, a code stream, an encoder, a decoder, and a storage medium. The decoding method includes: decoding a relevant syntax element of a current block; according to the relevant syntax element, determining to use an intra-template matching prediction (TMP) (IntraTMP) merged intra prediction mode to perform prediction on the current block; determining a matching block of the current block on the basis of a TMP mode, and determining a first predicted block of the current block according to the matching block; determining a second predicted block of the current block on the basis of a non-template matching intra prediction mode; and merging the first predicted block and the second predicted block to determine a final predicted block of the current block.

### CROSS-REFERENCE TO RELATED APPLICATION

The present application is a continuation of International Application No. PCT/CN2023/085280 filed on Mar. 30, 2023, the disclosure of which is hereby incorporated by reference in its entirety.

### BACKGROUND

In Intra Template Matching Prediction (Intra TMP) technologies, a template of a coding block is used to search for a matching template with the lowest cost in a search range predefined in the current image according to a preset cost function, and a reconstructed block corresponding to the matching template is used as a prediction block for the current coding block.

However, in an actual coding process, related technologies usually directly use reconstructed pixels of the matching block as prediction pixels of the current coding block, but due to incomplete consideration, there will be large deviations in some scenarios, resulting in low prediction accuracy.

### SUMMARY

The present disclosure relates to the field of video coding technologies, and particularly relates to an encoding method, a decoding method, a bitstream, an encoder, a decoder, and a storage medium.

The present disclosure provides an encoding method, a decoding method, and a storage medium.

The technical solution of the present disclosure may be implemented as follows.

In a first aspect, Embodiments of the present disclosure provide a method for decoding, which is applied to the decoder, and the method includes following operations.

A relevant syntax element of a current block is decoded, and the relevant syntax element is used for indicating whether the current block is predicted by using an intra template matching prediction (IntraTMP) fusion intra prediction mode.

It is determined that the current block is predicted by using the IntraTMP fusion intra prediction mode according to the relevant syntax element.

A matching block for the current block is determined based on a template matching prediction mode, and a first prediction block for the current block is determined according to the matching block.

A second prediction block for the current block is determined based on a non-template matching intra prediction mode.

The first prediction block and the second prediction block are fused to determine a final prediction block for the current block.

In a second aspect, the embodiments of the present disclosure provide a method for encoding, which is applied to the encoder, and the method includes following operations.

A matching block for the current block is determined based on a template matching prediction mode, and a first prediction block for the current block is determined according to the matching block.

A second prediction block for the current block is determined based on a non-template matching intra prediction mode.

The first prediction block and the second prediction block are fused to determine a final prediction block for the current block.

It is determined whether the current block is predicted by using an intra template matching prediction (IntraTMP) fusion intra prediction mode by performing coding determination according to the final prediction block of the current block and an original block for the current block.

A relevant syntax element of the current block is encoded, and the obtained encoded bits are signalled in a bitstream.

The relevant syntax element is used for indicating whether the current block is predicted by using the Intra TMP fusion intra prediction mode.

In a third aspect, the embodiments of the present disclosure provide a computer readable storage medium stored thereon a computer program and a bitstream, the computer program which, when executed by a processor, enables the processor to implement the method of the second aspect to generate the bitstream.

### BRIEF DESCRIPTION OF THE DRAWINGS

FIG. 1 is a schematic diagram of a prediction process for an Intra TMP technology.

FIG. 2 is a schematic diagram of a matching block for an Intra TMP technology.

FIG. 3 is a schematic diagram of template types for an Intra TMP technology.

FIG. 4A is a schematic diagram of a coarse search process for template matching in an Intra TMP technique.

FIG. 4B is a schematic diagram of a detailed search process for template matching in an Intra TMP technology.

FIG. 5 is a schematic diagram of a weighted fusion of an IntraTMP fusion prediction technology.

FIG. 6A is a schematic diagram of a filter shape.

FIG. 6B is a schematic diagram of a method of deriving a filter coefficient.

FIG. 7 is a schematic diagram of vertical and horizontal partition manners for a coding block.

FIG. 8A is a schematic block diagram of an encoder according to an embodiment of the present disclosure.

FIG. 8B is a schematic block diagram of a decoder according to an embodiment of the present disclosure.

FIG. 9 is a schematic diagram of a network architecture of a codec system according to an embodiment of the present disclosure.

FIG. 10 is a schematic flow diagram of a method for decoding according to an embodiment of the present disclosure.

FIG. 11 is a schematic flow diagram of a method for reordering matching blocks according to an embodiment of the present disclosure.

FIG. 12 is a schematic diagram of method for template prediction for an intra prediction mode according to an embodiment of the present disclosure.

FIG. 13 is a schematic diagram of a weighted fusion process for templates according to an embodiment of the disclosure.

FIG. 14 is a schematic flow diagram of a method for reordering intra prediction modes according to an embodiment of the present disclosure.

FIG. 15 is a schematic flow diagram of a method for determining a first candidate matching block group according to an embodiment of the present disclosure.

FIG. 16 is a schematic flow diagram of a method for encoding according to an embodiment of the present disclosure.

FIG. 17 is a schematic diagram of a configuration structure of an encoder according to an embodiment of the present disclosure.

FIG. 18 is a schematic structural diagram of a specific hardware of an encoder according to an embodiment of the present disclosure.

FIG. 19 is a schematic diagram of a configuration structure of a decoder according to an embodiment of the present disclosure.

FIG. 20 is a schematic structural diagram of a specific hardware of an encoder according to an embodiment of the present disclosure.

FIG. 21 is a schematic diagram of a configuration structure of a codec system according to an embodiment of the present disclosure.

### DETAILED DESCRIPTION

In order to provide a more detailed understanding of the features and technical contents of the embodiments of the present disclosure, the implementation of the embodiments of the present disclosure will be described in detail below in conjunction with the accompanying drawings, which are provided for illustration only and are not intended to limit the embodiments of the present disclosure.

Unless otherwise defined, all technical and scientific terms used herein have the same meanings as are commonly understood by those skilled in the art of the present disclosure. Terms used herein are for the purpose of describing the embodiments of the disclosure only and are not intended to limit the present disclosure.

In the following description, reference is made to “some embodiments” that describe a subset of all possible embodiments. However, it is to be understood that “some embodiments” may be the same subset or different subsets of all possible embodiments and may be combined with each other without conflict. It is further to be pointed out that, the terms “first/second/third” referred in embodiments of the present disclosure are merely used to distinguish similar objects, and do not represent a particular order for the objects. It is to be understood that “first/second/third” may be interchanged in a particular order or sequence where allowed, such that the embodiments of the disclosure described herein may be implemented in an order other than that illustrated or described herein.

Before further describing the embodiments of the present disclosure in detail, the terms and terminologies related to the embodiments of the present disclosure will be described first, and the terms and terminologies related to the embodiments of the present disclosure are applicable to the following explanations:
Coding block (CB);
Block matching (BM);
Coding unit (CU);
Block vector (BV);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient (NCC);
Rate Distortion Optimization (RDO);
H.266/Versatile Video Coding (VVC);
VVC Test Model (VTM);
Intra Template Matching Prediction (Intra TMP);
Enhanced Compression Model (ECM).

It is to be understood that in a video picture, a first colour component, a second colour component, and a third colour component are generally used to represent a coding block. The three colour components are one luma component, one blue chroma component, and one red chroma component, respectively. Specifically, the luma component is usually represented by the symbol Y, the blue chroma component is usually represented by the symbol Cb or U, and the red chroma component is usually represented by the symbol Cr or V. In this way, the video picture may be represented in the YCbCr format or in the YUV format.

### 1) IntraTMP Technology

The Intra TMP technology is a special intra prediction technology, and is referred to as IntraTMP technology for short. It is a special intra prediction coding tool, and is mainly used in screen content coding. The IntraTMP is mainly implemented by the following processes: part of the reconstructed pixels adjacent to the current coding block is selected as a template, the most similar template is searched for in a given reconstructed region of the current frame, and a reconstructed block corresponding to the most similar template is used as a matching block which is used as a prediction block for the current coding block. The template of the coding block is usually selected from a reconstructed region adjacent to the current coding block.

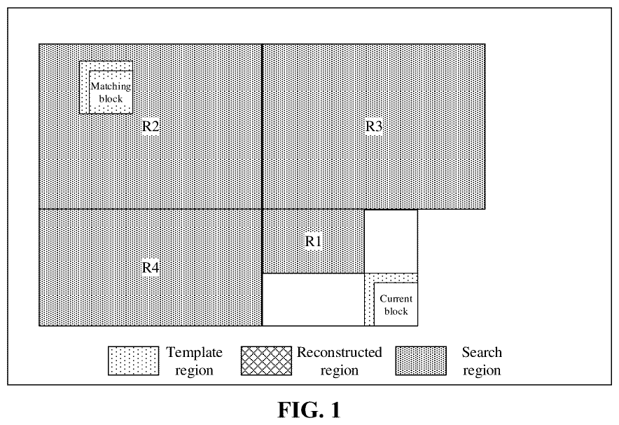

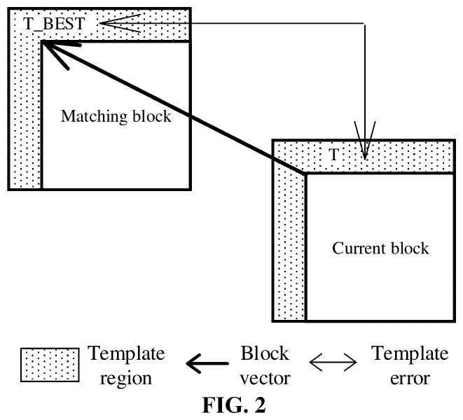

Exemplarily, taking an adjacent reconstructed region of the current block as an example, as illustrated in FIG. 1, the region filled with a grid represents a reconstructed region. In the reconstructed region, R1, R2, R3, and R4 are regions to be searched. R1 to R4 are sequentially searched to find a matching block. The adjacent region of the current block is the first template (T), and an adjacent region of the matching block (which may also be referred to as a “reference block”) is the second template (i.e., a “reference template” or referred to as a “matching template”, T_BEST). As illustrated in FIG. 2, both the encoder and the decoder search within the predefined search range in the current picture through the template (T) of the coding block, determine the matching template (T_BEST) with the smallest template error value, and then use the corresponding reconstructed block (Ref Block) of the matching template as the prediction block for the current coding block (Cur Block). The similarity between the templates is indicated by the template error value, and the smaller the template error value, the higher the similarity. In an embodiment of the present disclosure, the template error value may be a Sum of Absolute Difference (SAD), a Sum of Absolute Transformed Difference (SATD), a Mean Square Error (MSE), a Sum of Squared Differences (SSD), a Mean Absolute Deviation (MAD), a Mean Square Differences (MSD), a Normalized Correlation Coefficient (NCC), and the like, which is not specifically limited herein.

Exemplarily, taking the SAD as an example, the template error values at this case are as follows:

$$SAD ( {T}_{i} ) = {\sum }_{m = 0}^{M - 1} \vert {T}_{i , m} - {T}_{m} \vert , m = 0 , 1 , … , M - 1 \qquad ( 1 )$$

Where Tᵢ is the template in the search process, and M denotes the number of pixels in the template.

It is noted that the Intra TMP technique uses adjacent reconstructed pixels of the current block as a template, to search for a matching template in a predefined search region. The adjacent reconstructed pixels may be top reference pixels, top-left reference pixels, top-right reference pixels, left reference pixels, lower-left reference pixels, and the like of the current block. Therefore, according to whether the adjacent reconstructed pixels are available, template types may be classified and corresponding template types may be determined.

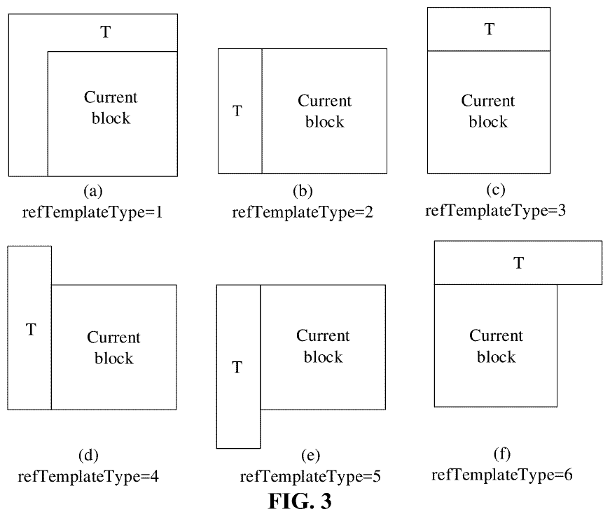

It is further to be noted that the template type may be represented by refTemplateType. FIG. 3 shows a schematic diagram of template types for the Intra TMP technology. As shown in FIG. 3, a block filled with the grid is a current block, and an adjacent area of the current block is a template T. Six template types are shown here.

Exemplarily, the six template types are as follows.

When the top-left reference pixels, the top reference pixels, and the left reference pixels are all available, a value of refTemplateType is 1, and the template shape is shown in (a) of FIG. 3.

When only the left reference pixels are available, the value of refTemplateType is 2, and the template shape is shown in (b) in FIG. 3.

When only the top reference pixels are available, the value of refTemplateType is 3, and the template shape is shown in (c) of FIG. 3.

When only the left reference pixels and the top-left reference pixels are available, the value of refTemplateType is 4, and the template shape is shown in (d) of FIG. 3.

When only the left reference pixels and the lower-left reference pixels are available, the value of refTemplateType is 5, and the template shape is shown in (c) in FIG. 3.

When only the top reference pixels and the top-right reference pixels are available, the value of refTemplateType is 6, and the template shape is shown in (f) in FIG. 3.

In the Intra TMP technology, the codec indicates whether the current coding block is encoded using the Intra TMP mode by a flag bit intra_tmp_flag. If the current coding block is encoded using the Intra TMP mode, the same template matching process is performed at the decoding side to obtain the same prediction block at the decoding side, and there is no need to additionally encode information of a block vector from the current coding block to the matching block. An example of the Intra TMP technology is given below.

### 2) IntraTMP Adaptation for Camera-Captured Content Technology

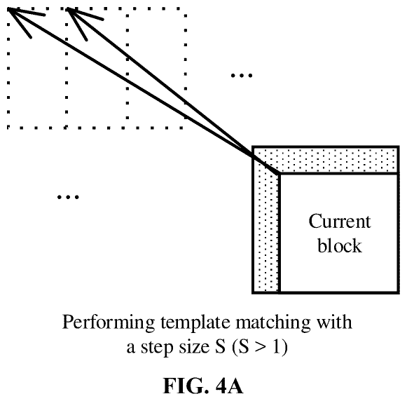

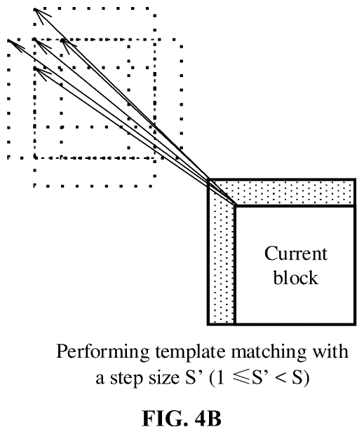

Based on the original IntraTMP technology, IntraTMP adaptation for camera-captured content technology proposes to perform template matching with a step size S (i.e. every S points in the horizontal or vertical directions, S>1) (as shown in FIG. 4A). For example, in the search area, instead of finding a matching block pixel by pixel according to raster scan, searching is performed every several pixels in the horizontal or vertical directions within the search area. For example, if a block vector for which the template matching is currently performed is (X0, Y0), the next block vector for which the template matching is performed should be (X0+S, Y0), and the ordinate of the block vector for which the template matching moving down is performed should be Y0+S. After the template matching is completed, an optimal matching block is refined within a certain range (as shown in FIG. 4B, template matching is performed with a smaller step size S′) to optimize the matching result. This technology can effectively reduce the complexity of IntraTMP mode while maintaining good coding efficiency.

### 3) IntraTMP Multi-Candidate Technology

In the IntraTMP multi-candidate technology, N candidate matching blocks are obtained from a reference region through a template matching process, or a list of candidate blocks with length N is constructed, and the candidate matching blocks in the list may be sorted according to the template error values between the candidate matching blocks and the current block. A candidate block is selected from the list through an index as a final prediction block. For a coding block using the IntraTMP multi-candidate technique, after the decoded IntraTMP flag bit intra_tmp_flag is true, intra_tmp_idx is decoded continuously. The syntax element intra_tmp_idx may represent an index of the selected candidate block.

intra_tmp_flag
if(intra_tmp_flag)
{
intra_tmp_idx
}

Exemplarily, a template matching process for constructing a list of candidate blocks is as follows.

In a first step, the first search is performed with a certain step size (for example, both the horizontal step size and the vertical step size are 4). N optimal matching blocks (the first N with smallest template error value) with a certain spacing are obtained.

In a second step, a second search is performed on the neighboring regions of the N matching blocks obtained in the first step. These neighboring regions may be set as a plurality of non-overlapping regions according to the step size in the first step. M optimal matching blocks (which may contain the matching blocks obtained in the first step) are obtained from these regions.

The same construction process is used at the encoding side and the decoding side to obtain the same list of candidate blocks.

Fixed-length encoding or variable-length encoding may be used for intra_tmp_idx, for example, truncated binary encoding may be used.

A variable length encoding method is:

The smaller the index (the smaller the intra_tmp_idx value), the smaller the template error value for the corresponding candidate block, and the greater the probability of being selected statistically. A shorter codeword may be set for a smaller intra_tmp_idx. For example:

| | |
|---|---|
| intra_tmp_idx | Binary symbol |

| | | |
|---|---|---|
| 0 | 1 | |
| 1 | 0 | 1 |
| 2 | 0 | 0 |
| Bin index | 0 | 1 |

If the maximum value N of intra_tmp_idx is larger, a codeword of the same length may be allocated to the larger intra_tmp_idx. For example, N is 15.

| | |
|---|---|
| Intra_tmp_idx | Binary symbol |

| | | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

In the above table, x may be obtained by using truncated binary.

### 4) IntraTMP Fusion Prediction Technology, Also Known as IntraTMP Multi-Matching Block Fusion Technology

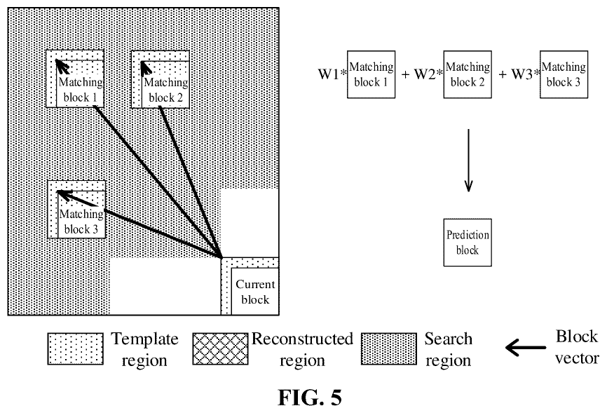

Through intra template matching, template error values between reconstructed blocks at different positions and the current coding block may be obtained. These reconstructed blocks may be represented by block vectors pointing from the current coding block to the reconstructed block. A list of candidate block vectors is constructed for recording block vectors with smaller template error values in the template matching process. One or more block vectors are selected from the list of candidate block vectors according to conditions such as block vector spacing, template error value, etc. Reconstructed blocks pointed by the block vectors are used as matching blocks for the current coding block. A weight value is determined for each matching block. Weighted fusion is performed on these matching blocks according to their weight values to obtain a final prediction block, thereby implementing IntraTMP combined fusion prediction. The process is shown in FIG. 5.

The number of matching blocks to be fused may be a fixed value, or may be determined according to the magnitude relationship of template error values for all matching blocks. For example, a threshold Threshold=minSAD<<1 is set for available N matching blocks, and minSAD is the smallest of the template error values for these matching blocks. Only matching blocks for which template error values are less than or equal to the threshold are used for the fusion process. By this method, the matching blocks used for fusion may be determined.

After the matching blocks used for fusion are determined, a weight for each matching block may be determined by using a preset fixed value, calculation according to the template error value, and derivation according to the template.

### 5) IntraTMP Filtering

The matching block (which may also be referred to as the reference block) obtained by intra template matching is usually directly used as the prediction block for the current block. The prediction block may be filtered to improve the prediction effect. A block-level flag bit may be used to indicate to the current block whether to use filtering processing for the prediction block.

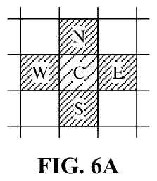

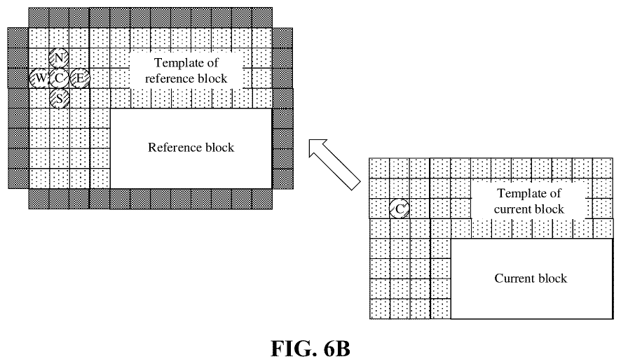

There are many forms of filters. One possible filter form is as follows:

$$PredC = c 0 C + c 1 N + c 2 S + c 3 E + c 4 W + c 5 B$$

Where C is a pixel to be filtered, N is a pixel on the top of C, S is a pixel on the lower of C, W is a pixel on the left of C, and E is a pixel on the right of C, as shown in FIG. 6A. B (Bias) is a fixed value, e.g. B is the median value in the range for pixels. c0 to c5 are filter coefficients.

One method for determining the filter coefficients is to train the coefficients of the filter by using a reference block template and a current block template. For example, a template region is a reconstruction area at 4 rows on the top and 4 columns on the left of the current block. For the reference block, additional regions at one line on the top, lower, left and right sides of the template area are also required as references. As shown in FIG. 6B, if part of the additional regions is not completely encoded, it may be copied from the template region.

One method for training filter coefficients is to calculate a set of coefficients so that the template error value between the filtered template of the reference block and the template of the current block is minimized.

If IntraTMP filtering is used for the current block, the prediction block directly obtained from the reference block is filtered, one way is to filter each pixel in order from left to right and from top to bottom. The filtered value is used as the predicted value.

### 6) Template-Derived IntraTMP Fusion

In the IntraTMP fusion prediction, multiple reference blocks may be obtained through intra template matching process, and weighted fusion is performed on these reference blocks. The weight values are typically predefined fixed values or obtained by calculating from template errors for all reference blocks. In the template-derived IntraTMP fusion method, a method similar to filter coefficient training is used, and the weights used for fusion prediction are obtained by performing training according to the template of each reference block and the template of the current block. For example, 5 reference blocks are used for weighted fusion in the form:

$$pred = {\sum }_{\text{?} = 0}^{4} w \text{?} * refBlock \text{?} + w \text{?} * Bias$$

$$\text{?} \text{indicates text missing or illegible when filed}$$

One method for calculating the weight is to calculate a set of coefficients so that the template error value between the template of the reference block after fusion and the template of the current block is minimized.

### 7) Template-Based Intra-Mode Derivation Technology

In the Template-Based Intra Mode Derivation (TIMD) technology, the reconstructed pixels of the L-shaped part adjacent to the current coding block are used as templates, and the predicted pixels of the template region in different intra prediction modes are calculated by traversing the MPM list, to obtain the template error values between the predicted pixels in different intra prediction modes and the reconstructed pixels, which are represented by the Sum of Absolute Transformed Difference (SATD). An optimal intra prediction mode is selected according to the template error values. At the decoding side, the intra prediction mode is obtained by the same derivation method, thereby reducing the encoded bits of mode information.

### 8) Combined Intra-Inter Prediction Technology

In the Combined Inter and Intra Prediction (CIIP) technology, by combining intra prediction and inter prediction, a weighted combination of an intra prediction block and an inter prediction block is used to obtain the prediction block for the current coding block. In ECM, CIIP is combined with template-based prediction technology, and different weight values are assigned to different regions, which further improves the prediction accuracy. Specifically, the intra prediction block pred_intra is obtained by the TIMD mode, and the inter prediction block pred_inter is obtained by the template-based Merge mode. According to the derived intra prediction mode and the position of the pixel to be predicted, the weight values wIntra, wInter are determined. The final prediction block Pred is calculated as follows:

$$Pred = ( wIntra * pred\_intra + wInter * pred\_inter + 4 ) ≫ 3$$

Here, wIntra and wInter are determined according to the intra prediction mode intra_dir derived from TIMD. There are 65 intra angle prediction modes in the ECM (2≤intra dir<=66). When 2≤intra_dir<34, the current coding block is vertically quartered. When 34<=intra_dir<=66, the current encoding block is horizontally quartered. The weight values wIntra and wInter of each region are:

| Region Index | (wIntra, wInter) |
|---|---|
| 0 | (6, 2) |
| 1 | (5, 3) |
| 2 | (3, 5) |
| 3 | 2~6 |

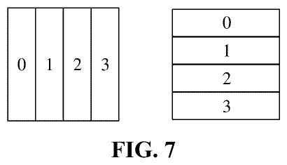

When being vertically or horizontally quartered, an index of each region is shown in FIG. 7. In particular, when intra_dir is equal to 0 or 1, the sub-region is not divided, and wIntra and wInter are selected from (3, 1), (2, 2), (1, 3) according to the coding types (intra or inter) for two coding blocks located on the left side and the top side.

### 9) IntraTMP Fusion Intra Prediction

In the IntraTMP fusion intra prediction mode, a matching block is obtained through intra template matching, it then fuses another intra prediction block to obtain a prediction block for the current coding block. Specifically, a matching block for the current coding block as a prediction block 1 is obtained by intra template matching; a prediction block 2 for the current coding block is obtained by an intra prediction mode other than IntraTMP; weight values for prediction blocks 1 and 2 are determined; weighted fusion is performed on these prediction blocks according to their weight values to obtain the final prediction block, so as to implement IntraTMP combined fusion prediction. Whether the fusion prediction mode is used may be indicated by a block-level flag bit.

Herein, the intra prediction mode may be derived by methods such as TIMD, and the weighted fusion process may be similar to the fusion process of the CIIP method, weight values related to the intra angle and pixel position are used to further improve the prediction accuracy.

### 10) Intra Block Copy Technology

The Intra Block Copy (IBC) technology is an intra prediction technology in which predicted pixels is obtained based on block matching. Similar to inter prediction, prediction is implemented by using a block vector pointing from the current block to the reference block, except that the reference block for inter prediction comes from an encoded reconstructed picture, while the reference block for IBC comes from a reconstructed portion of the current picture. Information of the block vector needs to be transmitted by the bitstream, so similar to the intra prediction, there are IBC-AMVP mode and IBC-Merge mode.

In the IBC-AMVP mode, the prediction block vector is obtained through the constructed list of candidate block vectors, and the reference block for the current block and the corresponding final block vector are obtained through hash search, full search, etc. The final block vector is coded according to the prediction block vector to improve the encoding efficiency.

IBC-Merge mode predicts through the constructed list of candidate block vectors, selects the optimal block vector in the list as the final block vector through SATD, RDO and other coding processes, and uses the reconstructed block pointed by it as the reference block to complete the prediction. The index of the block vector in the list is encoded instead of the block vector itself, which improves the encoding efficiency.

The list of candidate block vectors may be composed of coding information such as block vectors of adjacent coding blocks, historical block vectors, and average block vectors.

However, in the actual coding process, the above-mentioned Intra TMP technologies have their advantages. When applied individually, due to incomplete consideration, there will be large deviations in some scenarios, resulting in low prediction accuracy. In the embodiments of the present disclosure, by fusing a plurality of IntraTMP technologies, the IntraTMP technology may applicable to more application scenarios. Therefore, the accuracy of intra prediction is improved, which further improves the encoding/decoding performance.

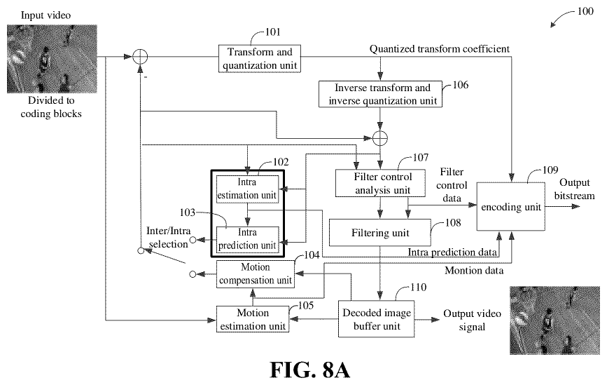

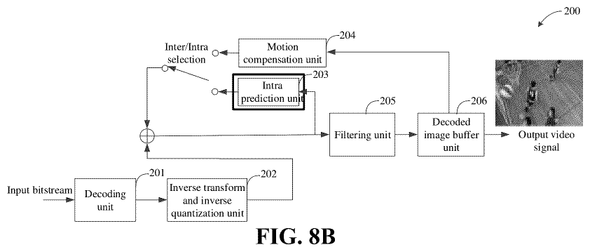

Referring to FIG. 8A, a schematic block diagram of an encoder provided by an embodiment of the present application is shown. As shown in FIG. 8A, an encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, a decoded image buffer unit 110, and the like. The filtering unit 108 may implement de-block filtering and Sample Adaptive Offset (SAO) filtering. The encoding unit 109 may implement header information coding and Context-based Adaptive Binary Arithmetic Coding (CABAC). For the input original video signal, a video coding block may be obtained by dividing a Coding Tree Unit (CTU). Then residual pixel information obtained after intra or inter prediction is transformed by the transform and quantization unit 101 for the video coding block, which includes that the residual information is transformed from the pixel domain to the transform domain, and the obtained transform coefficient is quantized to further reduce the bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used to encode the video coding block. The motion compensation unit 104 and the motion estimation unit 105 are configured to perform inter prediction coding of the received video coding block with respect to one or more blocks in the one or more reference pictures to provide temporal prediction information. The motion estimation performed by the motion estimation unit 105 is a process of generating a motion vector that may be used to estimate the motion of the video coding block. Then motion compensation is performed by the motion compensation unit 104 based on the motion vector determined by the motion estimation unit 105. After determining the intra prediction mode, the intra prediction unit 103 is further configured to supply the selected intra prediction data to the encoding unit 109, and the motion estimation unit 105 is also configured to transmit the motion vector data determined by calculation to the encoding unit 109. Further, the inverse transform and inverse quantization unit 106 is used for reconstruction of the video coding block, reconstructs a residual block in the pixel domain. Block effect artifacts are removed from the reconstructed residual block by the filter control analysis unit 107 and the filtering unit 108. Then the reconstructed residual block is added to the predictive block in a picture in the decoded image buffer unit 110 to generate the reconstructed video coding block. The encoding unit 109 is configured to encode various coding parameters and quantized transform coefficients. In a CABAC-based encoding algorithm, the context content may be based on adjacent coding blocks, and the encoding unit 109 may be used to encode information indicating the determined intra prediction mode, to output a bitstream for the video signal. The decoded image buffer unit 110 is used to store the reconstructed video coding block for prediction reference. As the video picture coding proceeds, new reconstructed video coding blocks are continuously generated and all of these reconstructed video coding blocks are stored in the decoded image buffer unit 110.

Referring to FIG. 8B, a schematic block diagram of a decoder provided by an embodiment of the present disclosure is shown. As shown in FIG. 8B, a decoder (specifically, a “video decoder”) 200 includes a decoding unit 201, an inverse transform and inverse quantization unit 202, an intra prediction unit 203, a motion compensation unit 204, a filtering unit 205, a decoded image buffer unit 206, and the like. The decoding unit 201 may implement header information decoding and CABAC decoding. The filtering unit 205 may implement block removal filtering and SAO filtering. After the input video signal is processed through the encoding process of FIG. 8A, a bitstream for the video signal is output. The bitstream is input into the decoder 200, first passes through the decoding unit 201 for obtaining the decoded transform coefficients. The transform coefficients are processed by the inverse transform and inverse quantization unit 202 to generate a residual block in the pixel domain. The intra prediction unit 203 may be configured to generate prediction data for a current video decoding block based on the determined intra prediction mode and data from previously decoding blocks in the current frame or picture. The motion compensation unit 204 determines prediction information for a video decoding block by parsing the motion vector and other associated syntax element, and uses the prediction information to generate a predictive block of the video decoding block being decoded. A decoded video block is formed by summing the residual block from the inverse transform and inverse quantization unit 202 with the corresponding predictive block generated by the intra prediction unit 203 or the motion compensation unit 204. The decoded video signal passes through the filtering unit 205 so as to remove block artifacts, which may improve the video quality. The decoded video block is then stored in a decoded image buffer unit 206, which stores the reference picture for subsequent intra prediction or motion compensation. The decoded image buffer unit 206 is also used to output the video signal. That is, the recovered original video signal is obtained.

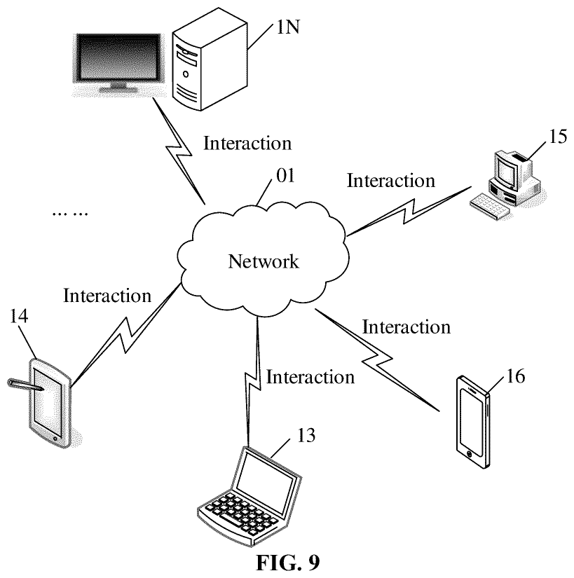

Further, an embodiment of the present disclosure further provides a network architecture of a codec system including an encoder and a decoder. FIG. 9 shows a schematic diagram of a network architecture of a codec system provided by an embodiment of the present disclosure. As shown in FIG. 9, the network architecture includes one or more electronic devices 13-1N and a communication network 01. The electronic devices 13-1N may perform video interaction through the communication network 01. In implementation, the electronic devices may be various types of devices having video encoding/decoding functions. For example, the electronic device may include a smartphone, a tablet, a personal computer, a personal digital assistant, a navigator, a digital phone, a video phone, a television, a sensing device, a server, and the like, and is not specifically limited herein. Further, the decoder or the encoder according to the embodiments of the present disclosure may be the above-described electronic device.

It is to be noted that the methods in the embodiments of the present disclosure are mainly applied to the intra prediction unit 103 as shown in FIG. 8A and the intra prediction unit 203 as shown in FIG. 8B. That is, the embodiments of the present disclosure may be applied to an encoder or a decoder, or may be applied to both the encoder and the decoder, which is not specifically limited in the embodiments of the present disclosure.

It is further to be noted that, when the methods in the embodiments of the present disclosure are applied to the intra prediction unit 103, “a current block” specifically refers to a coding block to be currently subjected to intra prediction. When the methods in the embodiments of the present disclosure are applied to the intra prediction unit 203, “a current block” specifically refers to a decoding block to be currently subjected to intra prediction.

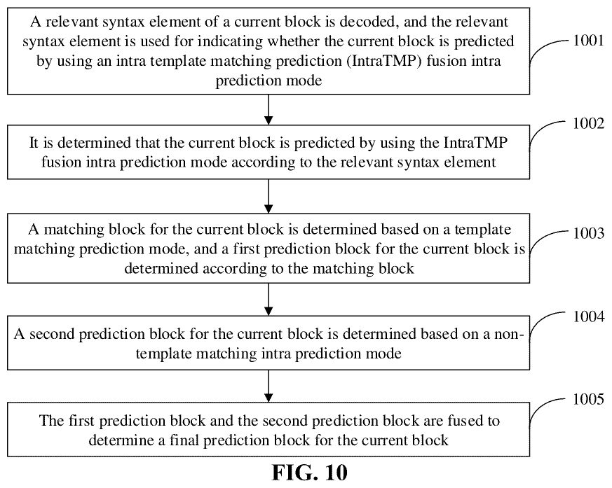

In an embodiment of the present disclosure, referring to FIG. 10, FIG. 10 illustrates a schematic flow diagram of a method for decoding according to an embodiment of the present disclosure. As illustrated in FIG. 10, the method may include operations S1001 to S1005.

At 1001, a relevant syntax element of a current block is decoded, and the relevant syntax element is used for indicating whether the current block is predicted by using an intra template matching prediction (IntraTMP) fusion intra prediction mode.

At 1002, it is determined that the current block is predicted by using the IntraTMP fusion intra prediction mode according to the relevant syntax element.

It is to be noted that the relevant syntax element may be understood as indicating a prediction mode for the current block. Specifically, it is used for indicating an IntraTMP prediction mode, and more specifically, it is used for indicating whether or not the prediction mode for the current block is the IntraTMP fusion intra prediction mode.

In some embodiments, the relevant syntax element includes at least one of: a first syntax element or a second syntax element. Herein the first syntax element is used for indicating whether the IntraTMP fusion intra prediction mode is allowed to be used for predicting the current block; and the second syntax element is used for indicating whether the current block is predicted by using the IntraTMP fusion intra prediction mode.

In some embodiments, the relevant syntax element further includes at least one of: a syntax element for indicating whether an IntraTMP prediction mode is allowed to be used for predicting the current block; a syntax element for indicating whether the current block is predicted by using an IntraTMP prediction mode other than an IntraTMP fusion prediction mode; a syntax element for indicating whether the current block is predicted by using an IntraTMP fusion prediction mode other than the IntraTMP fusion intra prediction mode; a syntax element indicating whether the current block is predicted by using the IntraTMP multi-matching block fusion prediction mode; and a syntax element for indicating whether the current block is predicted by using the IntraTMP multi-candidate prediction mode. In practical applications, these syntax elements may be one or more of: block-level syntax elements, slice-level syntax elements, tile-level syntax elements, picture-level syntax elements, or sequence-level syntax elements.

It is to be noted that the IntraTMP prediction mode refers to a prediction mode based on intra template matching, the IntraTMP fusion prediction mode may be understood as a fusion prediction mode based on intra template matching, and the IntraTMP fusion prediction mode includes the IntraTMP fusion intra prediction mode and other IntraTMP fusion prediction modes other than the IntraTMP fusion intra prediction mode. Exemplarily, other IntraTMP fusion prediction modes are any of prediction modes in which matching blocks obtained based on template matching participate in fusion, such as an IntraTMP multi-matching block fusion prediction mode, a combined intra-inter prediction mode, a template-derived IntraTMP fusion, etc.

It is to be noted that a value of the first syntax element may be a first value or a second value, and each value of the first syntax element is used to indicate a specific meaning. Exemplarily, when the value of the first syntax element is the first value, it indicates that the IntraTMP fusion intra prediction mode is allowed to be used for predicting the current block. Alternatively, when the value of the first syntax element is the second value, it indicates that the IntraTMP fusion intra prediction mode is allowed to be used for predicting the current block. Exemplarily, the first value may be 1, and the second value may be 0.

In some examples, the first syntax element includes a block-level syntax element. In some embodiments, the first syntax element further includes at least one of: a slice-level syntax element, a tile-level syntax element, a picture-level syntax element, or a sequence-level syntax element.

In some examples, the second syntax element includes a block-level syntax element. In some embodiments, the second syntax element further includes at least one of: a slice-level syntax element, a tile-level syntax element, a picture-level syntax element, or a sequence-level syntax element.

In some embodiments, the operation that the relevant syntax element of the current block is decoded includes followings: the first syntax element is decoded; when the value of the first syntax element is the first value, it is determined that the IntraTMP fusion intra prediction mode is allowed to be used for predicting the current block, and the second syntax element is decoded; when a value of the second syntax element is a first value, it is determined that the current block is predicted by using the IntraTMP fusion intra prediction mode; and when the value of the second syntax element is a second value, it is determined that the current block is predicted by using the IntraTMP multi-matching block fusion prediction mode.

It is to be noted that it is determined that the IntraTMP fusion intra prediction mode is allowed to be used for predicting the current block, and further, the second syntax element is decoded, and it is determined whether the current block is predicted by using the IntraTMP fusion intra prediction mode or the IntraTMP multi-matching block fusion prediction mode according to the value of the second syntax element. The IntraTMP multi-matching block fusion prediction and the IntraTMP fusion intra prediction are regarded as two fusion prediction modes, and a block level flag bit is used for indicating which fusion prediction mode is used.

Exemplarily, a relevant syntax element includes:

```
intra_tmp_flag
If( intra_tmp_flag)
{
  intra_tmp_fusion_flag
  If( intra_tmp_fusion_flag)
  {
    intra_tmp_intra_flag
  }
}
```

Here, intra_tmp_fusion_flag has a function of the first syntax element, intra_tmp_intra_flag has a function of the second syntax element, and intra_tmp_flag is used to indicate that the IntraTMP prediction mode is allowed to be used for predicting the current block. An IntraTMP related syntax element is decoded. If intra_tmp_flag is true, it indicates that an IntraTMP prediction mode is used for the current block, and then intra_tmp_fusion_flag is decoded. If intra_tmp_fusion_flag is true, it indicates that the IntraTMP fusion intra prediction mode is allowed to be used for predicting the current block. Further, intra_tmp_intra_flag is decoded, if intra_tmp_intra_flag is true, it indicates that the IntraTMP fusion intra prediction mode is used, if intra_tmp_intra_flag is false, it indicates that the IntraTMP multi-matching block fusion mode is used.

In some embodiments, the operation that the relevant syntax element of the current block is decoded includes followings: the first syntax element is decoded; when the value of the first syntax element is the first value, it is determined that the IntraTMP fusion intra prediction mode is allowed to be used for predicting the current block, and the second syntax element is decoded; when a value of the second syntax element is the first value, it is determined that the current block is predicted by using the IntraTMP fusion intra prediction mode; and when the value of the second syntax element is the second value, it is determined that the current block is predicted by using an IntraTMP multi-candidate prediction mode.

It is to be noted that it is determined that the IntraTMP fusion intra prediction mode is allowed to be used for predicting the current block, and further, the second syntax element is decoded, and it is determined whether the current block is predicted by using the IntraTMP fusion intra prediction mode or the IntraTMP multi-candidate prediction mode according to the value of the second syntax element. The IntraTMP multi-candidate prediction mode may be understood as an IntraTMP prediction mode based on a single matching block. IntraTMP multi-matching block fusion prediction and IntraTMP fusion intra prediction are regarded as two fusion prediction modes, and the IntraTMP multi-candidate prediction mode is an extension of the IntraTMP fusion intra prediction mode, in which a block level flag bit is used for indicating whether a selected matching block is fused with the second prediction block obtained by the intra prediction mode. Further, the selected first matching block may be indicated by an index value.

In some embodiments, the operation that the relevant syntax element of the current block is decoded includes followings: when the value of the first syntax element is the first value, it is determined that the current block is predicted by using the IntraTMP multi-matching block fusion prediction mode; when the value of the first syntax element is a second value, it is determined that the IntraTMP fusion intra prediction mode is allowed to be used for predicting the current block, and the second syntax element is decoded; when the value of the second syntax element is the first value, it is determined that the current block is predicted by using the IntraTMP fusion intra prediction mode; and when the value of the second syntax element is the second value, it is determined that the current block is predicted by using the IntraTMP multi-candidate prediction mode.

It is to be noted that when the value of the first syntax element is the first value, it is determined that the current block is predicted by using the IntraTMP multi-matching block fusion prediction mode. That is, it is determined that the IntraTMP fusion intra prediction mode is not allowed to be used for predicting the current block. The first syntax element is used to indicate whether the current block is predicted by using the IntraTMP multi-matching block fusion prediction mode in addition to indicating whether the IntraTMP fusion intra prediction mode is allowed to be used for predicting the current block. The IntraTMP multi-matching block fusion prediction mode, the IntraTMP multi-candidate prediction mode and the IntraTMP fusion intra prediction mode are used as three prediction modes, and the block level flag bit is used for indicating which prediction mode is selected, and indicating whether a selected matching block is fused with the second prediction block obtained by the intra prediction mode.

Exemplarily, a relevant syntax element includes:

```
intra_tmp_flag
If( intra_tmp_flag)
{
  intra_tmp_fusion_flag
  If(! intra_tmp_fusion_flag)
  {
    intra_tmp_intra_flag
  }
}
```

If intra_tmp_flag is true, it indicates that the IntraTMP prediction mode is used for the current block, and further intra_tmp_fusion_flag is decoded. If intra_tmp_fusion_flag is true, it indicates that the IntraTMP multi-matching block fusion mode is used for the current block. If intra_tmp_fusion_flag is false, it indicates that the prediction mode based on a single matching block is used for the coding block, or it may also indicate that the IntraTMP fusion intra prediction mode is allowed to be used for predicting the current blocks, and the intra_tmp_intra_flag is further decoded. If intra_tmp_intra_flag is true, it indicates that the IntraTMP fusion intra prediction mode is used, and if intra_tmp_intra_flag is false, it indicates that the prediction mode based on a single matching block is used, that is, the IntraTMP multi-candidate prediction mode is used.

In some embodiments, the foregoing prediction modes may also be fused with an IntraTMP filtering technique. For example, the relevant syntax element further includes a third syntax element. In some embodiments, the method further includes following operations: the third syntax element is decoded, herein the third syntax element is used for indicating whether to filter the first matching block or whether to filter a prediction block for the current block. Exemplarily, if a value of the third syntax element is a first value, it is determined to filter the first matching block or to filter the prediction block for the current block; if the value of the third syntax element is a second value, and it is determined not to filter the first matching block or not to filter the prediction block for the current block.

In some embodiments, the second syntax element and the third syntax element are decoded.

In some embodiments, it is determined that the IntraTMP fusion intra prediction mode is allowed to be used for predicting the current block, and the third syntax element is decoded. In some embodiments, it is determined that the current block is predicted by using the Intra TMP multi-candidate prediction mode, and the third syntax element is decoded.

It is to be noted that the first matching block is a first matching block determined based on the template matching prediction mode. The operation of filtering the first matching block or the prediction block for the current block may be pre-agreed. Alternatively, two syntax elements are used for indicating whether to filter the first matching block and whether to filter the prediction block for the current block, respectively. Alternatively, only one of them is configured with the syntax element, and the other one is pre-agreed.

Exemplarily, a relevant syntax element includes:

```
intra_tmp_flag
If( intra_tmp_flag)
{
intra_tmp_fusion_flag
  If( intra_tmp_fusion_flag)
  {
    intra_tmp_intra_flag
    intra_tmp_filter_flag
  }
}
or
intra_tmp_flag
If( intra_tmp_flag)
{
intra_tmp_fusion_flag
  If(! intra_tmp_fusion_flag)
  {
    intra_tmp_intra_flag
    intra_tmp_filter_flag
  }
}
```

On the basis of the above embodiments, if it is determined that the IntraTMP fusion intra prediction mode is allowed to be used for predicting the current block, intra_tmp_filter_flag is decoded. If intra_tmp_filter_flag is true, it indicates that the selected matching block is filtered. If intra_tmp_filter_flag is false, it indicates that the selected matching block is not filtered. It is to be noted that if intra_tmp_intra_flag is true, it indicates that the IntraTMP fusion intra prediction mode is used, and the selected first matching block is used for fusion intra prediction, and if intra_tmp_intra_flag is false, it indicates that the selected matching block is not fused with the intra prediction block, and it indicates that the prediction mode based on a single matching block is used, that is, the IntraTMP multi-candidate prediction mode is used.

In some embodiments, index information may also be transmitted to indicate which matching block in the list of candidate matching blocks is to be used for dusion. The relevant syntax element further includes a fourth syntax element. The method further includes following operations: it is determined that the IntraTMP fusion intra prediction mode is allowed to be used for predicting the current block, and the fourth syntax element is decoded. Herein the fourth syntax element is used for indicating an index value of a first matching block in the list of candidate matching blocks; or the fourth syntax element is used for indicating an index value of a first candidate matching block group in the list of candidate matching blocks.

Exemplarily, a relevant syntax element includes:

```
intra_tmp_flag
If( intra_tmp_flag)
{
  intra_tmp_fusion_flag
  If( intra_tmp_fusion_flag){
    intra_tmp_intra_flag
    intra_tmp_intra_idx
  }
}
```

If intra_tmp_intra_flag is true, it indicates that the IntraTMP fusion intra prediction mode is used, and intra_tmp_intra_idx indicates which matching block is fused with the intra prediction block. If intra_tmp_intra_flag is false, it indicates that the IntraTMP multi-matching block fusion mode is used, and intra_tmp_intra_idx indicates that which candidate matching block group in the list of candidate matching blocks is used for the multi-matching block fusion. Intra_tmp_intra_idx may also be referred to as intra_tmp_fusion_idx.

Exemplarily, a relevant syntax element includes:

```
intra_tmp_flag
If( intra_tmp_flag){
  intra_tmp_fusion_flag
  If(! intra_tmp_fusion_flag){
    intra_tmp_intra_flag
    intra_tmp_intra_idx
  }
}
```

If intra_tmp_intra_flag is true, it indicates that the IntraTMP fusion intra prediction mode is used, and intra_tmp_intra_idx indicates which matching block is fused with the intra prediction block. If intra_tmp_intra_flag is false, it indicates that the IntraTMP multi-candidate prediction mode is used, and intra_tmp_intra_idx indicates which matching block is used for predicting.

In some embodiments, the first syntax element and fourth syntax element are decoded. The fourth syntax element is used for indicating the index value of a first matching block in the list of candidate matching blocks; or the fourth syntax element is used for indicating the index value of the first candidate matching block group in the list of candidate matching blocks. In some embodiments, the first matching block corresponding to the current block is saved, and specifically, the BV of the first matching block is saved. In some embodiment, an index value of a first candidate matching block group corresponding to the current block is saved. In some embodiments, a preset matching block in the first candidate matching block group corresponding to the current block is saved as reference information for other decoding blocks.

In some embodiments, when the value of the first syntax element is the first value, it is determined that the current block is predicted by using the IntraTMP multi-matching block fusion prediction mode, and the index value of the first candidate matching block group is determined according to the fourth syntax element. When the value of the first syntax element is the second value, it is determined that the IntraTMP fusion intra prediction mode is allowed to be used for predicting the current block, and the second syntax element is decoded. When the value of the second syntax element is the first value, it is determined that the current block is predicted by using the IntraTMP fusion intra prediction mode. In some embodiments, the index value of the first matching block is determined according to the fourth syntax element. When the value of the second syntax element is the second value, it is determined that the current block is predicted by using the IntraTMP multi-candidate prediction mode. In some embodiments, the index value of the first matching block is determined according to the fourth syntax element.

Exemplarily, a relevant syntax element includes:

```
intra_tmp_flag
If( intra_tmp_flag){
  intra_tmp_fusion_flag
  intra_tmp_fusion_idx
  If(! intra_tmp_fusion_flag){
    intra_tmp_intra_flag
  }
}
```

If intra_tmp_flag is true, it indicates that the IntraTMP prediction mode is used for the current block, then intra_tmp_fusion_flag is decoded. If intra_tmp_fusion_flag is true, it indicates that the IntraTMP multi-matching block fusion mode is used for the current block, intra_tmp_fusion_idx indicates which candidate matching block group in the list of candidate matching blocks is used for performing the multi-matching block fusion. By transmitting the index value of the group, the optimal candidate matching block group may be quickly located, and the prediction accuracy and prediction efficiency may be improved. If intra_tmp_fusion_flag is false, it indicates that the prediction mode based on a single matching block is used for the coding block, or it may also indicate that the IntraTMP fusion intra prediction mode is allowed to be used for predicting the current blocks, and then the intra_tmp_intra_flag is decoded. If intra_tmp_intra_flag is true, it indicates that the IntraTMP fusion intra prediction mode is used, and intra_tmp_fusion_idx indicates which matching block is fused with the intra prediction block. If intra_tmp_intra_flag is false, it indicates that the prediction mode based on a single matching block is used, that is, the IntraTMP multi-candidate prediction mode is used, and intra_tmp_intra_idx indicates which matching block is used for predicting. For example, if intra_tmp_idx is equal to i, the (i+1)-th matching block in the list of candidate matching blocks is the selected matching block, the value of i starts from 0, and the index value starts from 1. Alternatively, if intra_tmp_idx is equal to i, the i-th matching block in the list of candidate matching blocks is the selected matching block, the value of i starts from 0, and the index value also starts from 0.

In some embodiments, the foregoing prediction modes may also be fused with IntraTMP filtering technique. Exemplarily, a relevant syntax element includes:

```
intra_tmp_flag
If( intra_tmp_flag)
{
intra_tmp_fusion_flag
  If( intra_tmp_fusion_flag)
  {
    intra_tmp_intra_flag
    intra_tmp_filter_flag
    intra_tmp_idx
  }
}
```

The IntraTMP related syntax element is decoded. If intra_tmp_flag is true, it indicates that the coding block is encoded by using IntraTMP mode, and then intra_tmp_fusion_flag is decoded. If intra_tmp_fusion_flag is true, it is determined that the IntraTMP fusion intra prediction mode is used, and intra_tmp_intra_flag, intra_tmp_filter_flag and intra_tmp_idx (the sequence may be switched) are further decoded. The intra_tmp_idx represents an index of the selected matching block in the list of candidate matching blocks. If intra_tmp_filter_flag is true, it indicates that the selected matching block is filtered, and if intra_tmp_filter_flag is false, it indicates that the selected matching block is not filtered. If intra_tmp_intra_flag is true, it indicates that the selected matching block is fused with the intra prediction block, and if intra_tmp_intra_flag is false, it indicates that the selected matching block is not fused with the intra prediction block.

```
intra_tmp_flag
If( intra_tmp_flag)
{
intra_tmp_fusion_flag
  If(! intra_tmp_fusion_flag)
  {
    intra_tmp_intra_flag
    intra_tmp_filter_flag
    intra_tmp_idx
  }
}
```

The IntraTMP related syntax element is decoded. If intra_tmp_flag is true, it indicates that the coding block is encoded by using the IntraTMP mode, and further intra_tmp_fusion_flag is decoded. If intra_tmp_fusion_flag is true, it indicates that the coding block is predicted by using the method of multi-matching block fusion. If intra_tmp_fusion_flag is false, it indicates that a prediction method based on a single matching block is used for the coding block, or it may also be understood as that it is determined that the IntraTMP fusion intra prediction mode is allowed to be used for predicting the current block, and further intra_tmp_intra_flag, intra_tmp_filter_flag and intra_tmp_idx (the sequence may be switched) are decoded. The intra_tmp_idx represents an index of the selected matching block in the list of candidate matching blocks. If intra_tmp_filter_flag is true, it indicates that the selected matching block is filtered, and if intra_tmp_filter_flag is false, it indicates that the selected matching block is not filtered. If intra_tmp_intra_flag is true, it indicates that the selected matching block is fused with the intra prediction block, if intra_tmp_intra_flag is false, it indicates that the selected matching block is not fused with the intra prediction block.

In some embodiments, intra_tmp_intra_idx and intra_tmp_fusion_idx may also be decoded in different ways according to intra_tmp_intra_flag. Exemplarily, the relevant syntax element further includes a fourth syntax element and a fifth syntax element. The method further includes following operations. It is determined that the current block is predicted by using the IntraTMP fusion intra prediction mode, the fourth syntax element is decoded; and an index value of the first matching block in the list of candidate matching blocks is determined according to the fourth syntax element. Alternatively, it is determined that the current block is predicted by using the IntraTMP multi-matching block fusion prediction mode, the fifth syntax element is decoded; and an index value of the first candidate matching block group in the list of candidate matching blocks is determined according to the fifth syntax element. An index range of the index values indicated by the fifth syntax element are the same as or different from an index range of the index values indicated by the fourth syntax element.

Exemplarily, a relevant syntax element includes:

```
intra_tmp_flag
If( intra_tmp_flag)
{
  intra_tmp_fusion_flag
  If( intra_tmp_fusion_flag) {
    intra_tmp_intra_flag
    intra_tmp_filter_flag
    if( intra_tmp_intra_flag)
        intra_tmp_intra_idx
      else
        intra_tmp_fusion_idx
  }
}
or
intra_tmp_flag
If( intra_tmp_flag)
{
  intra_tmp_fusion_flag
  If(! intra_tmp_fusion_flag)
  {
    intra_tmp_intra_flag
    intra_tmp_filter_flag
    if( intra_tmp_intra_flag)
      intra_tmp_intra_idx
  }
  else
  intra_tmp_fusion_idx
}
```

On the basis of the above embodiments, if it is determined that the current block is predicted by using the IntraTMP fusion intra prediction mode, intra_tmp_intra_idx (fourth syntax element) is decoded, and intra_tmp_intra_idx represents an index value of the selected matching block in the list of candidate matching blocks. If it is determined that the IntraTMP multi-matching block fusion prediction mode is used, intra_tmp_fusion_idx (the fifth syntax element) is decoded, and intra_tmp_fusion_idx represents the index value of the selected first candidate matching block group in the list of candidate matching block. A value range of intra_tmp_intra_idx may be the same as or different from a value range of intr_tmp_fusion_idx.

In some embodiments, intra_tmp_intra_idx and intra_tmp_idx may also be decoded in different ways according to intra_tmp_intra_flag. The relevant syntax element further includes a fourth syntax element and a sixth syntax element. The method further includes following operations. It is determined that the current block is predicted by using the IntraTMP fusion intra prediction mode, and the fourth syntax element is decoded; and the index value of the first matching block in the list of candidate matching blocks is determined according to the fourth syntax element. Alternatively, it is determined that the current block is predicted by using the IntraTMP multi-candidate prediction mode, and the sixth syntax element is decoded; and the index value of the first matching block in the list of candidate matching blocks is determined according to the sixth syntax element. An index range of the index values indicated by the sixth syntax element are the same as or different from an index range of the index values indicated by the fourth syntax element.

Exemplarily, a relevant syntax element includes:

```
intra_tmp_flag
If( intra_tmp_flag)
{
intra_tmp_fusion_flag
  If( ! intra_tmp_fusion_flag){
    intra_tmp_intra_flag
    intra_tmp_filter_flag
    If (intra_tmp_intra_flag)
      intra_tmp_intra_idx
    else
      intra_tmp_idx
  }
}
```

On the basis of the above embodiments, if it is determined that the current block is predicted by using the IntraTMP fusion intra prediction mode, intra_tmp_intra_idx (the fourth syntax element) is decoded, and intra_tmp_intra_idx represents the index value of the selected matching block in the list of candidate matching blocks. If it is determined that the IntraTMP multi-candidate prediction mode is used, intra_tmp_idx (the sixth syntax element) is decoded, and intra_tmp_idx represents the index value of the selected matching block in the list of candidate matching blocks. The value range of intra_tmp_intra_idx may be the same as or different from the value range of intr_tmp_idx. For example, the maximum value of the value range of intra_tmp_intra_idx is smaller than the maximum value of the value range of intra_tmp_idx, the value range of intra_tmp_intra_idx is 0-3, and the value range of intra_tmp_idx is 0-15.

In some embodiments, the IntraTMP fusion intra prediction and the IntraTMP filtering may not be used together. Exemplarily, the operation that it is determined that the current block is predicted by using the IntraTMP fusion intra prediction mode includes followings: it is determined not to filter the first matching block or not to filter the prediction block for the current block according to the value of the third syntax element, and the second syntax element is decoded; and when the value of the second syntax element is the first value, it is determined that the current block is predicted by using the IntraTMP fusion intra prediction mode.

Further, the method further includes following operation: a fourth syntax element is decoded. The fourth syntax element is used for indicating the index value of the first matching block in the list of candidate matching blocks.

Exemplarily, a relevant syntax element includes:

```
intra_tmp_flag
If( intra_tmp_flag)
{
intra_tmp_fusion_flag
  If( ! intra_tmp_fusion_flag){
    intra_tmp_filter_flag
    If( !intra_tmp_filter_flag)
      intra_tmp_intra_flag
    intra_tmp_idx
  }
}
```

On the basis of the above embodiments, if it is determined that the IntraTMP fusion intra prediction mode is allowed to be used for predicting the current block, intra_tmp_filter_flag (the third syntax element) is decoded. If intra_tmp_filter_flag is false, it indicates that a single matching block is not filtered, intra_tmp_intra_flag (the second syntax element) is decoded, and intra_tmp_idx (the fourth syntax element) is further decoded to determine the selected matching block. If intra_tmp_filter_flag is true, it indicates that a single matching block is filtered, and intra_tmp_idx is decoded to determine the selected matching block. In some embodiments, if intra_tmp_filter_flag is true, it may also indicate that prediction is performed by using the IntraTMP multi-candidate prediction mode. That is, it is determined whether or not to decode intra_tmp_intra_flag according to the value of intra_tmp_filter_flag.

In some embodiments, the IntraTMP fusion intra prediction and the IntraTMP filtering may not be used together. The method further includes that: it is determined that the current block is predicted by using the IntraTMP multi-candidate prediction mode, and the third syntax element is decoded, herein the third syntax element is used for indicating whether to filter the first matching block.

Further, the method further includes following operation: the fourth syntax element is decoded. The fourth syntax element is used for indicating the index value of the first matching block in the list of candidate matching blocks.

Exemplarily, a relevant syntax element includes:

```
intra_tmp_flag
If( intra_tmp_flag)
{
  intra_tmp_fusion_flag
  If(! intra_tmp_fusion_flag)
  {
    intra_tmp_intra_flag
    If( !intra_tmp_intra_flag)
      intra_tmp_filter_flag
    intra_tmp_idx
  }
}
```

On the basis of the above embodiments, if it is determined that the IntraTMP fusion intra prediction mode is allowed to be used for predicting the current block, intra_tmp_intra_flag (the second syntax element) is decoded. If intra_tmp_intra_flag is false, it indicates that an IntraTMP multi-candidate prediction mode is used for predicting, and intra_tmp_filter_flag (the third syntax element) is decoded to determine whether to filter a single matching block, and intra_tmp_idx (the fourth syntax element) is further decoded to determine the selected matching block. If intra_tmp_intra_flag is true, it indicates that prediction is performed by using the IntraTMP fusion intra prediction mode, and intra_tmp_idx (the fourth syntax element) is further decoded to determine the selected matching block. That is, it is determined whether or not to decode intra_tmp_filter_flag according to the value of intra tmp_intra_flag.

In some embodiments, a plurality of intra prediction modes may also be set, a particular intra prediction mode is indicated by transmitting a syntax element. The relevant syntax element further includes a seventh syntax element. The method further includes following operations: it is determined that the current block is predicted by using the IntraTMP fusion intra prediction mode and the seventh syntax element is decoded. The seventh syntax element is used for indicating a non-template matching intra prediction mode used for the current block.

Exemplarily, a relevant syntax element includes:

```
intra_tmp_flag
If( intra_tmp_flag)
{
  intra_tmp_fusion_flag
  If( intra_tmp_fusion_flag){
    intra_tmp_intra_flag
    If( intra_tmp_intra_flag)
      intra_tmp_intra_mode_idx
  }
}
or
intra_tmp_flag
If( intra_tmp_flag)
{
  intra_tmp_fusion_flag
  If( ! intra_tmp_fusion_flag){
    intra_tmp_intra_flag
    intra_tmp_filter_flag
    If (intra_tmp_intra_flag) {
      intra_tmp_intra_idx
      intra_tmp_intra_mode_idx
    }
    else
      intra_tmp_idx
  }
}
```

In the IntraTMP fusion intra prediction mode, a plurality of intra prediction modes may be set, such as a predefined intra prediction mode, an intra prediction mode from a matching block, and an intra prediction mode derived by a method such as TIMD or DIMD, and a certain intra prediction mode is selected by signalling an index. On the basis of the above embodiments, if it is determined that the current block is predicted by using the IntraTMP fusion intra prediction mode, that is, intra_tmp_intra_flag is true, the seventh syntax element (intra_tmp_intra_mode_idx) is decoded, and an intra prediction mode is determined according to intra_tmp_intra_mode_idx, for determining the second prediction block.

In some embodiments, the relevant syntax element includes a first syntax element (intra_tmp_fusion_flag), and the method further includes following operations. When a value of the first syntax element is a first value, it is determined that the IntraTMP fusion intra prediction mode is allowed to be used for predicting the current block, and a first prediction template of the current block is determined by predicting in a template region of the current block by using the IntraTMP fusion intra prediction mode. A first template error value is determined according to the first prediction template and a template of the current block. A second prediction template of the current block is determined by predicting in the template region of the current block by using a first IntraTMP prediction mode. A second template error value is determined according to the second prediction template and the template of the current block. When a minimum template error value is the first template error value, it is determined that the current block is predicted by using the IntraTMP fusion intra prediction mode. When the minimum template error value is the second template error value, it is determined that the current block is predicted by using the first IntraTMP prediction mode. The first IntraTMP prediction mode includes at least one of the IntraTMP multi-matching block fusion prediction mode or the IntraTMP multi-candidate prediction mode.

That is, when intra_tmp_fusion_flag is true, it is not necessary to decode intra_tmp_intra_flag. According to at least one of the template error value for the multi-matching block fusion prediction in the template region or the template error value for the multi-candidate prediction in the template region, and the template error value for the fusion intra prediction in the template region, the prediction mode to be used is selected.

In some embodiments, the method further includes following operation: an eighth syntax element is decoded. Herein the eighth syntax element is used for indicating whether to decode part or all of syntax elements in the relevant syntax element of the current block. In some embodiments, the eighth syntax element includes at least one of: a sequence-level syntax element, a picture-level syntax element, a tile-level syntax element, a slice-level syntax element, or a block-level syntax element.

It is to be noted that part or all of syntax elements in the relevant syntax element may be controlled by one or more of the block-level syntax element, the slice-level syntax element, the tile-level syntax element, the picture-level syntax element and the sequence-level syntax element. That is, a corresponding eighth syntax element may be set for each of syntax elements in the relevant syntax element, or a corresponding eighth syntax element may be set for two or more of syntax elements in the relevant syntax element, or a corresponding eighth syntax element may be set for all of syntax elements in the relevant syntax element. For example, when the relevant syntax element is a block-level syntax element, the eighth syntax element may be a picture-level and/or sequence-level syntax element.

At 1003, a matching block for the current block is determined based on a template matching prediction mode, and a first prediction block for the current block is determined according to the matching block.

It is to be noted that template matching is performed, to construct a list of candidate matching blocks. Possible matching blocks are searched for in a preset search range according to a preset search method, and template error values corresponding to the matching blocks are calculated according to the templates of the matching blocks and the template of the current block. The list of candidate matching blocks is constructed according to all matching blocks and the corresponding template error values. The list of candidate matching blocks may be ordered in an ascending order according to the template error values.

Exemplarily, the template matching process for constructing the list of candidate blocks is as follows.

In a first step, the first search is performed with a certain step size (for example, both the horizontal step size and the vertical step size are 4). N optimal matching blocks (the first N matching blocks with smallest template error values) with a certain spacing are obtained.

In a second step, a second search is performed on the neighboring regions of the N matching blocks obtained in the first step. These neighboring regions may be set as a plurality of non-overlapping regions according to the step size in the first step. M optimal matching blocks (which may contain the matching blocks obtained in the first step) are obtained from these regions. The same construction process is used at both the encoding side and the decoding side to obtain the same list of candidate blocks.

In some embodiments, the operation that the matching block for the current block is determined based on the template matching prediction mode includes followings: the first list of candidate matching blocks for the current block is constructed based on template matching; a first candidate matching block group is determined from the first list of candidate matching blocks; and at least one matching block for fusion is determined from the first candidate matching block group. Accordingly, the operation that the first prediction block for the current block is obtained according to the matching block includes following: at least one matching block in the first candidate matching block group is fused to determine the first prediction block for the current block. That is, in the IntraTMP fusion intra prediction method, at least one matching block for the current block is determined in combination with the IntraTMP multi-matching block fusion prediction mode to perform the matching block fusion, so as to obtain the first prediction block for the current block. In some embodiments, the fused matching block may also be filtered to obtain a first prediction block.

In some embodiments, the operation that the matching block for the current block is determined based on the template matching prediction mode includes followings: a second list of candidate matching blocks for the current block is constructed based on template matching; and a first matching block is determined from the second list of candidate matching blocks. That is, the list of second candidate matching blocks may be understood as a list constructed in the IntraTMP multi-candidate prediction mode, and is a list used to determine a single matching block. In the IntraTMP fusion intra prediction mode, the first matching block for the current block is determined in combination with the IntraTMP multi-candidate prediction mode, and the first prediction block for the current block is obtained according to the first matching block.

Accordingly, the operation that the first prediction block for the current block is obtained according to the matching block includes following operations: the first matching block is used as the first prediction block; or when the first matching block is determined to be filtered, the first matching block is filtered to obtain the first prediction block. In the IntraTMP fusion intra prediction mode, the IntraTMP filtering method is combined to further improve the prediction accuracy.

In some embodiments, the operation that the first matching block is determined from the second list of candidate matching blocks includes followings: a matching block having a minimum template error is determined from the second list of candidate matching blocks as the first matching block; or an index value of the first matching block is determined, and the first matching block is determined from the second list of candidate matching blocks according to the index value of the first matching block. That is, the IntraTMP fusion intra prediction mode is extended by using the IntraTMP multi-candidate prediction mode, the first prediction block is obtained by using the selected matching block, and the first prediction block is fused with the second prediction block obtained by using the intra prediction mode. By combining the IntraTMP multi-candidate prediction mode and the IntraTMP fusion intra prediction mode, prediction accuracy may be improved.

It is to be noted that the length of the second list of candidate matching blocks is not same as the length of the first list of candidate matching blocks. In some embodiments, the length of the second list of candidate matching blocks is same as the length of the first list of candidate matching blocks, and it may also be understood as that the first list of candidate matching blocks and the second list of candidate matching blocks are the same list of candidate matching blocks.

In some embodiments, the operation that the first matching block is determined from the second list of candidate matching blocks further includes followings: first N matching blocks in the second list of candidate matching blocks are reordered; and index values of the first N matching blocks are determined according to reordered positions of the first N matching blocks.

The operation that the first matching block is determined from the second list of candidate matching blocks according to the index value of the first matching block includes following: the first matching block is determined from the second list of candidate matching blocks according to the index value of the first matching block and the index values of the first N matching blocks. N is less than or equal to the number of matching blocks in the second list of candidate matching blocks.

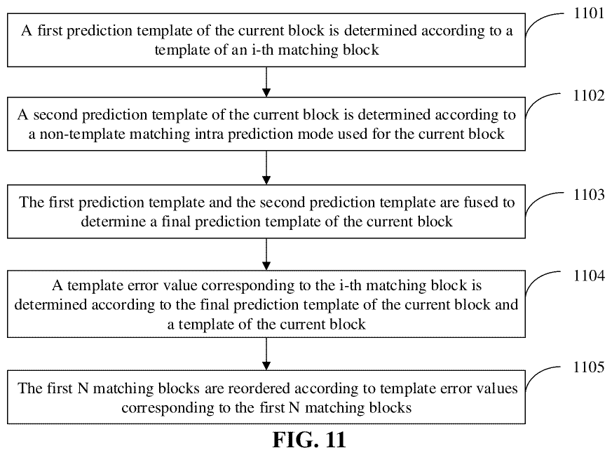

FIG. 11 is a schematic flow diagram of a method for reordering matching blocks according to an embodiment of the present disclosure. As shown in FIG. 11, the first N matching blocks in the second list of candidate matching blocks includes operations 1101 to 1105.

At 1101, a first prediction template of the current block is determined according to a template of an i-th matching block.

In some embodiments, the template of the i-th matching block is used as the first prediction template of the current block, or the templates of the matching blocks are filtered to obtain the filtered prediction template.

At 1102, a second prediction template of the current block is determined according to a non-template matching intra prediction mode used for the current block.

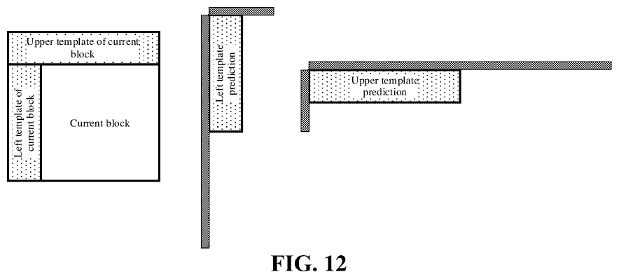

FIG. 12 is a schematic diagram of a method for template prediction for an intra prediction mode according to an embodiment of the present disclosure. As shown in FIG. 12, available reference pixels in an adjacent region of a template of the current block are determined according to the type of the template of the current block, and then intra prediction other than IntraTMP is implemented in the template region through these reference pixels. The intra prediction method may be a preset intra prediction mode, such as a Planar mode, or an intra prediction mode derived according to a method such as TIMD by using the template region.

At 1103, the first prediction template and the second prediction template are fused to determine a final prediction template of the current block.

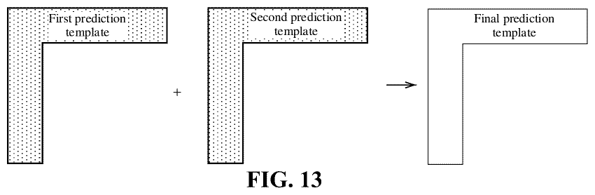

FIG. 13 is a schematic diagram of a weighted fusion process for templates according to an embodiment of the disclosure. When the upper left reference pixels, the upper reference pixels, and the left reference pixels of the current block are all available, the shape of the template of the current block is as shown in FIG. 13, and the first prediction template of the matching block and the second prediction template for intra prediction are fused to obtain the final prediction template of the current block. Further, the template error value of the specific prediction method may be obtained by comparing the prediction template with the template of the current block.

The first prediction template and the second prediction template are weighted fused. For example, if the first prediction template is pred_tmp, the second prediction template is pred_intra, and the weight values are wTmp and wIntra, the final prediction template Pred is:

$$Pred = ( wTmp * pred\_tmp + wIntra * pred\_intra + offset ) ≫ shift$$

At 1104, a template error value corresponding to the i-th matching block is determined according to the final prediction template of the current block and a template of the current block.

At 1105, the first N matching blocks are reordered according to template error values corresponding to the first N matching blocks.

The template error values SADi corresponding to the N matching blocks are reordered in an ascending order.

In some embodiments, when the non-template matching intra prediction mode used for the current block is determined, the first N matching blocks are used to perform template prediction in the template region, thereby calculating prediction templates corresponding to different matching blocks. The template error values are calculated according to the prediction templates and the template of the current block, reordering is performed according to the template error values, and an optimal matching block is selected, or a smaller index value of a matching block is selected for encoding.

In some embodiments, when it is determined to filter the first matching block according to intra_tmp_filter_flag, the method further includes following operations: a filter coefficient for a matching block is determined according to a template of the first matching block and a template of the current block; and the first matching block is filtered according to the filter coefficient for the matching block to obtain the first prediction block. If intra_tmp_filter_flag is true, the filter coefficient is derived according to the template of the selected matching block and the template of the current block, and the filtering form may be:

$$predC = c 0 C + c 1 N + c 2 S + c 3 E + c 4 W + c 5 B$$

For the filter shape as shown in FIG. 6A, predC is a pixel value of the template of the current block, C is a value of a pixel to be filtered in the template of matching block, N is a pixel on the top of C, S is a pixel on the lower of C, W is a pixel on the left of C, and E is a pixel on the right of C. B (Bias) is a fixed value, e.g. B is the median value of the pixel range. c0 to c5 are filter coefficients. The matching block is filtered by using filter coefficients c0 to c5 derived from the template to obtain a first prediction block. If intra_tmp_filter_flag is false, the selected matching block is directly used as the first prediction block.

At 1004, a second prediction block for the current block is determined based on a non-template matching intra prediction mode.

In some embodiments, the non-template matching intra prediction mode corresponding to the current block may be a specific intra prediction mode agreed in advance by the encoding/decoding sides. For example, the non-template matching intra prediction mode includes one of: a predefined intra prediction mode, an intra prediction mode of a matching block, an intra prediction mode derived based on TIMD, or an intra prediction mode derived based on DIMD.

In some embodiments, the method further includes following operations: it is determined that the current block is predicted by using the IntraTMP fusion intra prediction mode, and the seventh syntax element is decoded to determine the non-template matching intra prediction mode corresponding to the current block.

In some embodiments, the non-template matching intra prediction mode includes at least two candidate intra prediction modes. The method further includes following operations: the at least two candidate intra prediction modes are reordered to obtain a list of candidate intra prediction modes and an index value of each candidate intra prediction mode; an index value of a first intra prediction mode used for a current picture is determined; the first intra prediction mode is determined from the list of candidate intra prediction modes according to the index value of the first intra prediction mode; and the first intra prediction mode is used as a non-template matching intra prediction mode used for the current block.

In some embodiments, an optimal intra prediction mode with a minimum template error value is determined as the first intra prediction mode. In some other embodiments, the seventh syntax element is decoded to determine the non-template matching intra prediction mode used for the current block.

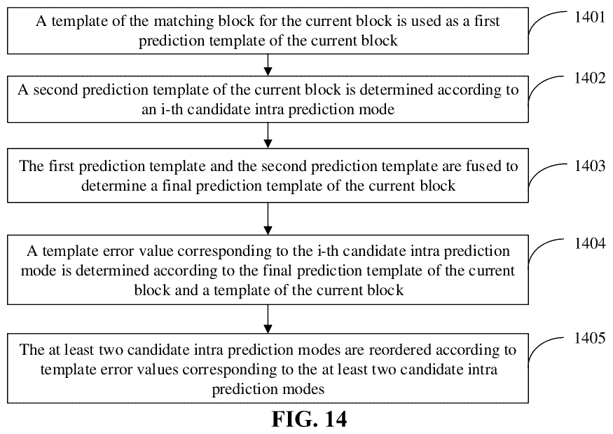

FIG. 14 is a schematic flow diagram of a reordering method for an intra prediction mode according to an embodiment of the present disclosure. As shown in FIG. 14, the operation that at least two candidate intra prediction modes are reordered includes steps 1401 to 1405.

At 1401, a template of the matching block for the current block is used as a first prediction template of the current block.

At 1402, a second prediction template of the current block is determined according to an i-th candidate intra prediction mode.

At 1403, the first prediction template and the second prediction template are fused to determine a final prediction template of the current block.

At 1404, a template error value corresponding to the i-th candidate intra prediction mode is determined according to the final prediction template of the current block and a template of the current block.

At 1405, the at least two candidate intra prediction modes are reordered according to template error values corresponding to the at least two candidate intra prediction modes.

In some embodiments, when the matching block used by the current block is determined, a plurality of intra prediction modes are used to perform template prediction in the template region, thereby calculating prediction templates corresponding to different intra prediction modes. The template error values are calculated according to the prediction templates and the template of the current block, reordering is performed according to the template error values, to select an optimal matching block, or to select a smaller index value of an intra prediction mode for encoding.

At 1005, the first prediction block and the second prediction block are fused to determine a final prediction block for the current block.

It is to be noted that the fusion weight values for the first prediction block and the second prediction block may be predefined fixed values, or may be flexibly selected according to the characteristic of the current block.

In some embodiments, the operation that the first prediction block and the second prediction block are fused to determine the final prediction block for the current block includes following operation: the first prediction block and the second prediction block are fused according to a preset first weight value and a preset second weight value to determine the final prediction block for the current block.

In some embodiments, the operation that the first prediction block and the second prediction block are fused to determine the final prediction block for the current block includes following operations. The current block are partitioned into four sub-regions based on an intra prediction mode derived based on TIMD; first weight values and second weight values for the four sub-regions of the current block are determined, respectively; and the first prediction block and the second prediction block are fused according to the first weight values and the second weight values for the four sub-regions of the current block to determine the final prediction block for the current block. Alternatively, a first weight value and a second weight value for the current block are determined based on the intra prediction mode derived based on TIMD; and the first prediction block and the second prediction block are fused according to the first weight value and the second weight value for the current block to determine the final prediction block for the current block.

For example, the weight values are determined for the prediction block 1 and the prediction block 2 according to the intra prediction mode derived by TIMD and the position of the pixel to be predicted. For example, the current coding block is partitioned according to the intra prediction mode intra_dir derived by TIMD, and different weight values are set for the prediction block 1 and the prediction block 2 in different regions. For example, there are 65 intra angle prediction modes in the ECM (2≤intra_dir<=66). When 2≤intra_dir<34, the current coding block is vertically quartered. When 34<=intra_dir<=66, the current encoding block is horizontally quartered. The indexes of the regions vertically quartered or horizontally quartered are shown in FIG. 7. The weight value wTMP for the prediction block 1 and the weight value wIntra for the prediction block 2 in each region are as follows.

| Region Index | (wIntra, wInter) |
|---|---|
| 0 | (6, 2) |
| 1 | (5, 3) |
| 2 | (3, 5) |
| 3 | (2, 6) |

When intra_dir is equal to 0 or 1, the region is not partitioned to subregions, and (wIntra, wTMP) is equal to (1, 3). (wIntra, wTMP) may also be equal to (3, 1) or (2, 2).

Prediction block 1 and prediction block 2 are weighted fused. For example, if prediction block 1 is pred_tmp, prediction block 2 is pred_intra, and the weight values are wTmp and wIntra, the final prediction block Pred is:

$$\begin{matrix}Pred = ( wTmp * pred\_tmp + wIntra * pred\_intra + offset ) ≫ shift \\ Where offset = 1 ≪ ( shift - 1 ) , shift = {log}_{2} ( wIntra + wTMP ) .\end{matrix}$$

In some embodiments, when it is determined to filter the prediction block for the current block according to intra_tmp_filter_flag, the method further includes following operations: a filter coefficient for a prediction block is determined according to a prediction template of the current block and the template of the current block; and the prediction block for the current block is filtered according to the filter coefficient for the prediction block to obtain the final prediction block for the current block. If intra_tmp_filter_flag is true, the filter coefficient is derived according to the selected prediction template and the template of the current block, and the filtering form may be:

$$predC = c 0 C + c 1 N + c 2 S + c 3 E + c 4 W + c 5 B$$

For the filter shape as shown in FIG. 6A, predC is a pixel value of the template of the current block, C is a value of a pixel to be filtered in the prediction template, N is a pixel on the top of C, S is a pixel on the lower of C, W is a pixel on the left of C, and E is a pixel on the right of C. B (Bias) is a fixed value, e.g. B is the median value of the pixel range. c0 to c5 are filter coefficients. The fused prediction block is filtered by using the filter coefficients c0 to c5 derived from the template to obtain the final prediction block for the current block. If intra_tmp_filter_flag is false, the fused prediction block is directly used as the final prediction block.

Further, a process of performing prediction by using the IntraTMP multi-matching block fusion prediction mode is illustrated by way of an example. In some embodiments, when it is determined that the current block is predicted by using the IntraTMP multi-matching block fusion prediction mode according to the relevant syntax element, the method further includes followings: a first list of candidate matching blocks for the current block is constructed based on template matching; a first candidate matching block group is determined from the first list of candidate matching blocks; and at least one matching block in the first candidate matching block group is fused to determine a prediction block for the current block.

In some embodiments, the operation that the first candidate matching block group is determined from the first list of candidate matching blocks includes following: the first N matching blocks in the first list of candidate matching blocks form the first candidate matching block group. N is an integer greater than 0, for example, N is 3.

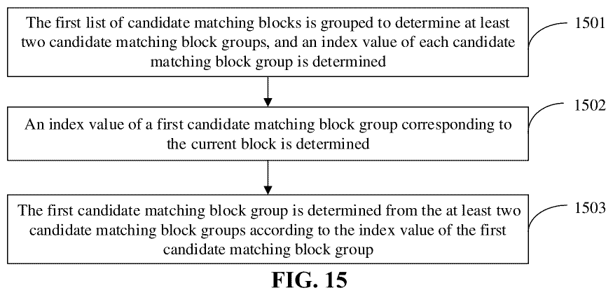

FIG. 15 is a schematic flow diagram of a method for determining the first candidate matching block group according to an embodiment of the present disclosure. As shown in FIG. 15, in some other embodiments, the operation that the first candidate matching block group is determined from the first list of candidate matching blocks includes operations 1501 to 1503.

At step 1501, the first list of candidate matching blocks is grouped to determine at least two candidate matching block groups, and an index value of each candidate matching block group is determined.

Exemplarily, the first list of candidate matching blocks is grouped according to at least one grouping rule. Each grouping rule specifies the number of groups, the number of matching blocks in each candidate matching block group, the distance between matching blocks in each candidate matching block group, or the like. In the embodiments of the present disclosure, the first list of candidate matching blocks may be grouped through one or more grouping rules to determine at least two candidate matching block groups, and a candidate matching block group include at least one matching block.

In some embodiments, the operation that the first list of candidate matching blocks is grouped includes following operation: the first list of candidate matching blocks is grouped according to at least one grouping rule. Each grouping rule specifies the number of groups, the number of matching blocks in each candidate matching block group, the distance between matching blocks in each candidate matching block group, or the like.

In some embodiments, the at least one grouping rule includes a first grouping rule. The first grouping rule includes following operation: starting from the first matching block in the first list of candidate matching blocks, every first preset number of matching blocks are set as one candidate matching block group. The first preset number is an integer greater than 0. Here, the first preset number is the number of matching blocks in each candidate matching block group.

The maximum length of the list of candidate matching blocks constructed by the template matching process is N, for example, N is equal to 45. The fusion prediction may use at most M matching blocks for fusion. For example, M is equal to 3. The first preset number is set to 3, and every M matching blocks in the list of candidate matching blocks may be set to one group according to the first grouping rule, and a total of N/M=15 groups are obtained. If the total length N of the list of candidate matching blocks cannot be divisible by the maximum fusion number M, the number of matching blocks in the last group should be less than M, and the other matching blocks in the list candidate matching blocks may be added to the last group. That is, the first grouping rule further includes following operations: if the number of matching blocks in the last candidate matching block group is less than the first preset number, the preset matching blocks in the first list of candidate matching blocks are obtained and added to the last candidate matching block group, so that the number of matching blocks in the last candidate matching block group is equal to the first preset number.

The at least one grouping rule includes a second grouping rule. The second grouping rule includes following operation: starting from the first matching block in the first list of candidate matching blocks, every second preset number of matching blocks are set as one candidate matching block group. The second preset number is an integer greater than 0, and the first preset number is different from the second preset number.

The maximum length of the list of candidate matching blocks constructed by the template matching process is N, for example, N is equal to 15. The fusion prediction may use at most M matching blocks for fusion. For example, M is equal to 5, the second preset number is set to 5, and every M matching blocks in the list of candidate matching blocks may be set to one group according to the second grouping rule, and a total of N/M=3 groups are obtained. Accordingly, the second grouping rule further includes following operations: if the number of matching blocks in the last candidate matching block group is less than the second preset number, the preset matching blocks in the first list of candidate matching blocks are obtained and added to the last candidate matching block group, so that the number of matching blocks in the last candidate matching block group is equal to the second preset number.

In some embodiments, the at least one grouping rule includes the first grouping rule and the second grouping rule. Exemplarily, the maximum length of the list of candidate matching blocks constructed by the template matching process is N, for example, N is equal to 15. The first preset number is set to 3. The second preset number is set to 5. At most N/M=5 groups are obtained according to the first grouping rule, and at most N/M=3 groups are obtained according to the second grouping rule. The list of candidate matching blocks is grouped according to the first grouping rule and the second grouping rule to obtain a total of 8 groups.

In some embodiments, each grouping rule further includes a corresponding number of groups. For example, when the number of groups corresponding to the first grouping rule is 2 and the number of groups corresponding to the second grouping rule is 2, the list of candidate matching blocks is grouped according to the first grouping rule and the second grouping rule to obtain a total of 4 groups. For example, a candidate block in the list of candidate matching blocks is BVn, n takes an integer from 1 to n, or n takes an integer from 0 to N−1. In some embodiments, i may be an index value of a candidate matching block. Two candidate matching block groups are obtained according to the first grouping rule, i.e., {BV0, BV1, BV2}, {BV3, BV4, BV5}, and two candidate matching block groups are obtained according to the second grouping rule, i.e., {BV0, BV1, BV3, BV2, BV4}, {BV5, BV6, BV7, BV8, BV9}.

In some embodiments, the at least one grouping rule includes a third grouping rule. The third grouping rule includes following operation: the first M1 matching blocks in the first list of candidate matching blocks and every M2 matching blocks starting from the (M1+1)-th matching block are formed into a candidate matching block group. In some embodiments, the third grouping rule further includes a corresponding number of groups.

In some embodiments, the third grouping rule further includes that the values of M2 in different matching block groups are same, or the third grouping rule further includes that the values of M2 in different matching block groups are not completely same.

Exemplarily, BVn (i>N) is combined with the first M1 matching blocks in the list of candidate matching blocks. For example, M1=2, M2=1, then possible combinations are {BV0, BV1, BV2}, {BV0, BV1, BV3}, {BV0, BV1, BV4}, etc. M1=2, then the possible combination is {BV0, BV1, BV2, BV3}, {BV0, BV1, BV4}, {BV0, BV1, BV5}, etc. BVn to BV (n+M2) (n>N) are combined with the first N matching blocks in the list of candidate matching blocks. For example, M1=1, M2=2, then possible combinations are {BV0, BV1, BV2}, {BV0, BV3, BV4}, {BV0, BV5, BV6}, etc.

In some embodiments, the at least one grouping rule includes a first grouping rule and a third grouping rule. The at least one grouping rule includes a first grouping rule, a second grouping rule and a third grouping rule. Exemplarily, each grouping rule further includes a corresponding number of groups.

In some embodiments, the at least one grouping rule includes a fourth grouping rule. The fourth grouping rule includes following operation: the first i matching blocks in the first list of candidate matching blocks form an i-th candidate matching block group; herein i takes an integer greater than 0. For example, the first one matching block forms the first candidate matching block group, the first two matching blocks form the second candidate matching block group, the first three matching blocks form the third candidate matching block group, the first four matching blocks form the fourth candidate matching block group, and so on. If the maximum length of the list of candidate matching blocks is N, then the maximum value of i is N, and the number of groups may be limited by limiting the maximum value of i.

In some embodiments, the fifth grouping rule includes following operations: the first 2ⁱ matching blocks in the first list of candidate matching blocks are formed into an i-th candidate matching block group. The fifth grouping rule includes following operation: the first (2i+a) matching blocks in the first list of candidate matching blocks are formed into an i-th candidate matching block group, and a takes a positive integer.

In some embodiments, grouping may also be performed based on the distance between matching blocks. Exemplarily, the grouping rule further includes following operations: a distance between any two matching blocks in the candidate matching block group is greater than a first distance threshold. Alternatively, the grouping rule further includes that a distance between any two matching blocks in the candidate matching block group is less than a second distance threshold. The distribution of the matching blocks in the candidate matching block group may be limited by limiting the distance between the matching blocks. It is to be noted that when two or more grouping rules are set, all or part of grouping rules limit the distribution of the matching blocks in the candidate matching block group.

In some embodiments, the operation that the first list of candidate matching blocks is grouped includes following operations: the first list of candidate matching blocks is grouped according to at least one grouping rule to obtain at least one candidate matching block group; at least one corresponding fusion mode of IntraTMP fusion prediction mode is set for each candidate matching block group, to obtain at least two candidate matching block groups.

It is to be noted that, after grouping the first list of candidate matching blocks according to any one of the above grouping embodiments, one or more fusion modes may be set for the candidate matching block group. It is be understood as that one candidate matching block group and one fusion mode are combined into one new candidate matching block group, and two fusion modes are set for one candidate matching block group, such that two new candidate matching block groups are formed.

Exemplarily, according to the first grouping rule and the second grouping rule, two candidate matching block groups are obtained, i.e., {BV0, BV1, BV2, BV3, BV4} and {BV0, BV1}. Two fusion modes are set for each candidate group to obtain four candidate matching block groups {BV0, BV1, BV2, BV3, BV4, bFilter=1}, {BV0, BV1, BV2, BV3, BV4, bFilter=0}, {BV0, BV1, bFilter=1}, {BV0, BV1, bFilter=0}. bFilter=1 denotes the first fusion mode and bFilter=0 denotes the second fusion mode.

Exemplarily, the fusion mode includes a fusion mode of intra template matching based on template derivation and a fusion mode of intra template matching based on template error values.

The first fusion mode is the fusion mode of intra template matching based on template derivation, and the second fusion mode is the fusion mode of intra template matching based on template error values. Exemplarily, a grouping result includes: {BV0, BV1, BV2, BV3, BV4, bFilter=1}, {BV0, BV1, BV2, BV3, BV4, bFilter=0}, {BV0, BV1, bFilter=1}, {BV0, BV1, bFilter=0}. Exemplarily, another grouping result includes: {BV0, BV1, BV2, BV3, BV4, bFilter=1}, {BV0, BV1, BV2, BV3, BV4, bFilter=0}, {BV0, BV1, BV2, bFilter=1}, {BV0, BV1, bFilter=0}, etc.

In some embodiments, the encoding side and the decoding side pre-agree on one grouping rule or one grouping rule combination.

In some embodiments, the method further includes following operations: the bitstream is decoded to determine the at least one grouping rule. Exemplarily, a syntax element is decoded for indicating a grouping rule, or for indicating a grouping rule combination, and the grouping rule combination includes at least two preset grouping rules.

In some embodiments, when the encoding side and the decoding side pre-agree on one or more grouping rules in advance, the method includes following operation: the bitstream is decoded to determine variable parameters in the grouping rules. Exemplarily, the encoding side and the decoding side pre-agree the first grouping rule in advance, and the method includes following operations: the bitstream is decoded to determine the first preset number. The method further includes following operations: a bitstream is decoded to determine the number of groups.

That is, one or more grouping rules may be set. For example, one grouping rule is to use up to M1 matching blocks for fusion, for example, M1 equals 3. Every M1 matching blocks in the list of candidate matching blocks is set as one group. Another grouping rule is to use up to M2 matching blocks for fusion, for example, M2 equals 2. Every M2 matching blocks in the list of candidate matching blocks are set as one group. These two grouping rules are used alone or in combination to obtain the matching block groups.

In some embodiments, the operation that the index value of each candidate matching block group is determined includes followings: a first index value of each candidate matching block group is determined according to a group position of the candidate matching block group; and the first index value of the candidate matching block group is used as the index value of the candidate matching block group. It may be understood as that a method for selecting a certain matching block group is that an index value is used to indicate which group is used.

In some embodiments, the operation that an index value of each candidate matching block group is determined includes followings: the at least two candidate matching block groups are reordered according to a template error value corresponding to each candidate matching block group; a second index value of each candidate matching block group is determined according to a reordered position of the candidate matching block group; and the second index value of each candidate matching block group is used as the index value of the candidate matching block group. It may be understood as that these matching block groups are reordered, and then a certain matching block group is determined according to the index value.

In some embodiments, the operation that the at least two candidate matching block groups are reordered includes followings. N fusion matching blocks for fusion are determined from each candidate matching block group, herein N takes an integer greater than 0. Fusion weight values for the N fusion matching blocks are determined. Templates of the N fusion matching blocks are fused according to fusion weight values of the N fusion matching blocks to determine a prediction template corresponding to each candidate matching block group. A template error value corresponding to each candidate matching block group is determined according to a prediction template corresponding to the candidate matching block group and a template of the current block. Reordering is performed according to the template error value corresponding to each candidate matching block group.

At 1502, an index value of a first candidate matching block group corresponding to the current block is determined.

For example, the first candidate matching block group may be a specific candidate matching block group in at least two candidate matching block groups. That is, the index value of the first candidate matching block group may be a preset index value. For example, the index value of the first candidate matching block group is the minimum index value, the index values of the candidate matching block groups are arranged in an ascending order, the smaller the index value, the smaller the template error value of the matching block, and the candidate matching group corresponding to the minimum index value after grouping is directly obtained as the first candidate matching group.

Alternatively, the encoding side uses at least two candidate matching block groups to perform fusion prediction respectively, and the optimal candidate matching block group is selected by a coding determination process such as SATD and RDO, and the encoding side encodes an index value of the optimal candidate matching block group or an index value corresponding to the reference block. The first candidate matching block group is determined according to the index value, IntraTMP multi-matching block fusion prediction is implemented by using the matching block in the first candidate matching block group, to determine the final prediction block or the first prediction block for the current block.

In some embodiments, intra_tmp_intra_idx or intra_tmp_fusion_idx is decoded to determine the index value of the first candidate matching block group.

At 1503, the first candidate matching block group is determined from the at least two candidate matching block groups according to the index value of the first candidate matching block group.

Further, IntraTMP multi-matching block fusion prediction is implemented by using the matching blocks in the first candidate matching block group, to determine the final prediction block or the first prediction block for the current block.

Further, the method for fusing matching blocks according to the embodiments of the present disclosure will be further described by way of an example. The operation that the at least one matching block in the first candidate matching block group is fused to determine the prediction block for the current block includes followings. N fusion matching blocks for fusion are determined from the first candidate matching block group, herein N takes an integer greater than 0. Fusion weight values for the N fusion matching blocks are determined. The N fusion matching blocks are fused according to fusion weight values of the N fusion matching blocks to determine the prediction block for the current block.

In some embodiments, the operation that the N fusion matching blocks for fusion are determined includes followings: the first N matching blocks in a current candidate matching block group are used as the N fusion matching blocks; here N is less than or equal to the number of matching blocks in the current candidate matching block group. That is, if the number N of matching blocks for fusion is less than the number M of matching blocks, only N matching blocks may be used to derive the fusion weight values and to perform the weighted calculation, and if the number N of matching blocks for fusion is equal to the number M of matching blocks, all matching blocks may be used to derive the fusion weight values and to perform the weighted calculation. For example, the number of fusion blocks N=3, BV0, BV1, and BV2 are always fused.

In some embodiments, the method further includes following operation: a value N of the number of fusion matching blocks is encoded. Exemplarily, the relevant syntax element further includes a syntax element intra_tmp_fusion_num, which is used to indicate the value N of the number of fusion matching blocks.

In some embodiments, the operation that the fusion weight values for the N fusion matching blocks are determined may include followings: the fusion weight values for the N fusion matching blocks are determined according to a fusion mode of an IntraTMP fusion prediction mode corresponding to a current candidate matching block group. Herein the fusion mode is an intra template matching fusion mode based on template derivation or an intra template matching fusion mode based on template error values.

In some embodiments, the fusion mode is the intra template matching fusion mode based on template derivation, and the operation that fusion weight values for the N fusion matching blocks are determined includes followings: fusion weight values for the N fusion matching blocks and fusion weight value for the bias parameter are determined according to templates of the N fusion matching blocks, a template of the current block, and the bias parameter.

The operation that the N fusion matching blocks are fused according to the fusion weight values for the N fusion matching blocks to determine the prediction block for the current block includes followings: the N fusion matching blocks and the bias parameter are fused according to the fusion weight values for the N fusion matching blocks and the fusion weight value for the bias parameter to determine the prediction block for the current block.

For example, in the IntraTMP fusion method based on the template derivation, a method similar to a filter coefficient training is used to obtain the weights used for fusion prediction by performing training according to the template of each matching block and the template of the current block. For example, the candidate matching block group or candidate matching block set includes three matching blocks, denoted as {BV (3i), BV1 (3i+1), BV2 (3i+2)}, and the fusion form is as follows:

$$pred = w 0 * {BV}_{3 * i} + w 1 * {BV}_{3 * i} + w 2 * {BV}_{3 * i + 2} + w 3 * Bias$$

The templates of matching blocks BV (3i), BV1 (3i+1) and BV2 (3i+2) are taken as input, the template of the current block is taken as output pred, to drive a set of weight values w0 to w3, Bias is a fixed value, such as the median value of the pixel range. When the matching blocks are fused, the prediction block for the current block may be obtained by using the reconstruction values and weight values w0 to w3 for the matching blocks BV (3i), BV1 (3i+1) and BV2 (3i+2) in a same fusion manner. Alternatively, when the templates of the matching blocks are fused, a prediction template is obtained by using the reconstruction values and weight values w0 to w3 for the templates of the matching blocks BV (3i), BV1 (3i+1) and BV2 (3i+2) in the same fusion manner.

In some embodiments, the fusion mode is the intra template matching fusion mode based on template error values, and the operation that fusion weight values for the N fusion matching blocks are determined includes followings: template error values for the N fusion matching blocks are determined according to templates of the N fusion matching blocks and a template of the current block; an accumulative sum of template error values for the N fusion matching blocks is determined according to the template error values for the N fusion matching blocks; and the fusion weight values for the N fusion matching blocks are determined according to the template error values for the N fusion matching blocks and the cumulative sum of the template error values.

For example, the template error values of the templates of N matching blocks and the template of the current block are SAD, which are SAD1 to SADn, respectively, and a weight calculation method is as follows:

$$\begin{matrix}SADi = ( SADi == 0 ) ? 1 : SADi \\ SUM = {\sum }_{i = 1}^{n} {SAD}_{i} \\ Wi = ( SUM - SADi ) / ( ( n - 1 ) * SUM )\end{matrix}$$

Where n is the total number of matching blocks (i.e., N), and Wi is the weight value corresponding to the matching block whose template error value is SADi. The fusion form is as follows.

$$Pred = {\sum }_{i = 1}^{n} {W}_{i} \times Predi$$

Where Pred is a prediction block or a prediction template, and Predi is a matching block or a template of the matching block. According to the above fusion method, the fused template error value corresponding to each matching block group is obtained. The matching block groups are reordered in an ascending order according to the template error values. That is, the smaller the template error value, the smaller the index value corresponding to the matching block group. The selected candidate matching block group is obtained according to the determined index value, and the selected candidate matching block group and the corresponding weight values are used to complete weighted fusion prediction for the current block to obtain a final prediction block.

In some embodiments, the operation that the N fusion matching blocks for fusion are determined includes followings. The matching blocks in the current candidate matching block group are divided into at least two sets of candidate matching blocks. Herein each set of candidate matching blocks includes N fusion matching blocks for fusion, and the numbers of fusion matching blocks in different sets of candidate matching blocks are not exactly the same and the fusion matching blocks in different sets of candidate matching blocks are not exactly the same. Fusion weight values for the N fusion matching blocks in each set of candidate matching blocks are determined. Templates of N fusion matching blocks are fused according to the fusion weight values for the N fusion matching blocks in each set of candidate matching blocks to determine a prediction template corresponding to the set of candidate matching blocks. A template error value corresponding to each set of candidate matching blocks is determined according to a prediction template corresponding to the set of candidate matching blocks and a template of the current block. The optimal set of candidate matching blocks with the smallest template error value is determined according to the template error value corresponding to each set of candidate matching blocks. The matching blocks in the optimal set of candidate matching blocks are used as the N fusion matching blocks.

It is to be noted that when the matching block for the current block is predicted, the current candidate matching block group is the first candidate matching block group. when at least two candidate matching block groups are reordered and the at least two candidate matching block groups are used for template prediction, the current candidate matching block group is a currently selected candidate matching block group.

Exemplarily, the current candidate matching block group includes three matching blocks {BV (3i), BV1 (3i+1), BV2 (3i+2)}, and the sets of candidate matching blocks that may be attempted for template prediction are {BV (3i)}, {BV (3i), BV1 (3i+1)}, {BV (3i), BV1 (3i+1), BV2 (3i+2)}, and weight values are derived for each set for a specific fusion mode. The optimal set of candidate matching blocks is determined, and the matching blocks in the optimal set of candidate matching blocks are fused to determine the final prediction block or the first prediction block for the current block.

In some embodiments, the operation that the at least one matching block in the first candidate matching block group is fused includes followings. A template error value for each matching block in the first candidate matching block group is determined. A template error threshold value is determined according to a template error value for an i-th matching block in the first candidate matching block group and a threshold value coefficient. Herein the i-th matching block is the matching block with the smallest template error value in the current candidate matching block group. When a template error value of an (i+j)-th matching block is greater than the template error threshold, the i-th matching block in the first candidate matching block is used as an (i+j)-th fusion matching block. Fusing is performed by using all matching blocks in the updated first candidate matching block group.

For example, according to the template error value for each matching block in the current candidate matching block group, part of the matching blocks may be selected for fusion. For example, the candidate matching block group includes three matching blocks, {BV0, BV1, BV2}, and the threshold value (threshold) is set according to the template error value SAD0 corresponding to BV0. When

$$\begin{matrix}threshold = a * SAD 0 \\ SADi \leq threshold , i > 0\end{matrix}$$

are satisfied, the corresponding BVi is used for fusion prediction, so as to determine the number of matching blocks for fusions. Here, SAD0 corresponds to the minimum template error value for the matching blocks in the candidate matching block group, and a may be any preset value, such as 1.2, 1.5, or 2. If all SADi are less than or equal to the threshold, the fusion form is as follows:

$$pred = w 0 * BV 0 + w 1 * BV 1 + w 2 * BV 2 + w 3 * Bias$$

If there is a matching block whose template error value is greater than the threshold, for example, SAD2>threshold, at this case, fusion coefficient derivation and weighted calculation may be performed by replacing BV2 with BV0. That is, the templates of BV0, BV1, and BV0 are used as input and the template of the current block is used as output, to derive the coefficients w0 to w3. The fusion form is as follows:

$$Pred = w 0 * BV 0 + w 1 * BV 1 + w 2 * BV 0 + w 3 * Bias$$

If the number N of matching blocks for fusion is less than the maximum number M of matching blocks for fusions, only the N matching blocks may be used to derive coefficients and perform weighted calculation. For example, N=2, and the fusion form is as follows:

$$Pred = w0 * BV 0 + w 1 * BV 1 + w 2 * Bias$$

Further, a process of performing prediction by using the IntraTMP multi-candidate prediction mode is illustrated by way of an example. When it is determined that the current block is predicted by using the IntraTMP multi-candidate prediction mode, the method includes following operations: a second list of candidate matching blocks for the current block is constructed based on template matching; a first matching block is determined from the second list of candidate matching blocks; and a prediction block for the current block is determined according to the first matching block.

In some embodiments, the operation that the first matching block is determined from the second list of candidate matching blocks includes followings: an index value of the first matching block is determined, and the first matching block is determined from the second list of candidate matching blocks according to the index value of the first matching block.

Accordingly, the operation that the first prediction block for the current block is determined according to the first matching block includes following operations: the first matching block is used as the prediction block; or when it is determined to filter the first matching block, the matching block is filtered to obtain the prediction block.

In some embodiments, the operation that the first matching block is determined from the second list of candidate matching blocks includes followings: a matching block with a minimum template error is determined from the second list of candidate matching blocks as the first matching block; or an index value of the first matching block is determined, and the first matching block is determined from the second list of candidate matching blocks according to the index value of the first matching block.

In some embodiments, the operation that the first matching block is determined from the second list of candidate matching blocks further includes followings: first N matching blocks in the second list of candidate matching blocks are reordered; index values of the first N matching blocks are determined according to reordered positions of the first N matching blocks; and the first matching block is determined according to the index value of the first matching block. The method for reordering the matching blocks is referred to FIG. 11 and the corresponding description thereof.

By using the above technical solutions, the decoding side decodes the relevant syntax element, and determines whether the current block is predicted by using the IntraTMP fusion intra prediction mode, thereby improving the prediction efficiency. Meanwhile the IntraTMP fusion intra prediction mode combines IntraTMP technologies such as IntraTMP multi-candidate, IntraTMP multi-matching block fusion and IntraTMP filtering to adapt to more encoding/decoding scenarios, thereby ensuring prediction accuracy and the efficiency of encoding/decoding.

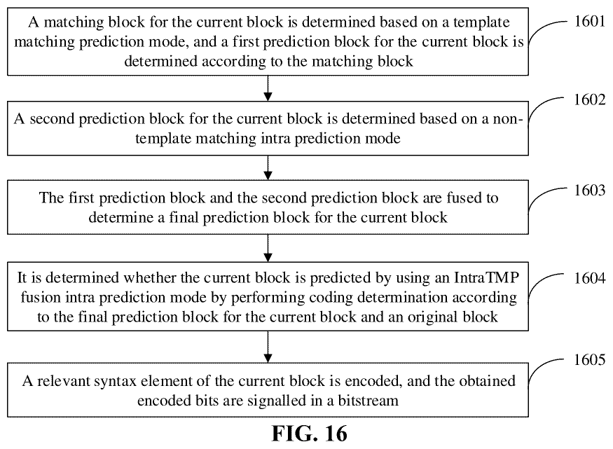

In another embodiment of the present disclosure, a method for encoding is further provided, referring to FIG. 16, FIG. 16 illustrates a schematic flow diagram of a method for encoding according to an embodiment of the present disclosure. As illustrated in FIG. 16, the method includes operations S1601 to S1605.

At 1601, a matching block for the current block is determined based on a template matching prediction mode, and a first prediction block for the current block is determined according to the matching block.

It is to be noted that template matching is performed, to construct a list of candidate matching blocks. Possible matching blocks are searched for in a preset search range according to a preset search method, and template error values corresponding to the matching blocks are calculated according to the templates of the matching blocks and the template of the current block. The list of candidate matching blocks is constructed according to all matching blocks and the corresponding template error values. The list of candidate matching blocks may be ordered in an ascending order according to the template error values.

In some embodiments, the operation that the matching block for the current block is determined based on the template matching prediction mode includes followings: the first list of candidate matching blocks for the current block is constructed based on template matching; a first candidate matching block group is determined from the first list of candidate matching blocks; and at least one matching block for fusion is determined from the first candidate matching block group. Accordingly, the operation that the first prediction block for the current block is obtained according to the matching block includes followings: at least one matching block in the first candidate matching block group is fused to determine the first prediction block for the current block. That is, in the IntraTMP fusion intra prediction method, at least one matching block for the current block is determined in combination with the IntraTMP multi-matching block fusion prediction mode to perform the matching block fusion, so as to obtain the first prediction block for the current block.

In some embodiments, the operation that the first candidate matching block group is determined from the first list of candidate matching blocks includes followings: the first list of candidate matching blocks is grouped to determine at least two candidate matching block groups, and an index value of each candidate matching block group is determined; an index value of the first candidate matching block group corresponding to the current block is determined; and the first candidate matching block group is determined from the at least two candidate matching block groups according to the index value of the first candidate matching block group.

In some embodiments, the operation that the index value of each candidate matching block group is determined includes followings: a first index value of each candidate matching block group is determined according to a group position of the candidate matching block group; and the first index value of the candidate matching block group is used as the index value of the candidate matching block group.

Alternatively, the at least two candidate matching block groups are reordered according to a template error value corresponding to each candidate matching block group; a second index value of each candidate matching block group is determined according to a reordered position of the candidate matching block group; and the second index value of each candidate matching block group is used as the index value of the candidate matching block group.

In some embodiments, the operation that the at least one matching block in the first candidate matching block group is fused includes followings. A template error value for each matching block in the first candidate matching block group is determined. A template error threshold value is determined according to a template error value of an i-th matching block in the first candidate matching block group and a threshold value coefficient. Herein the i-th matching block is the matching block with the smallest template error value in the current candidate matching block group. When a template error value of an (i+j)-th matching block is greater than the template error threshold, the i-th matching block in the first candidate matching block is used as an (i+j)-th fusion matching block. Fusing is performed by using all matching blocks in an updated first candidate matching block group.

In some embodiments, the operation that the matching block for the current block is determined based on the template matching prediction mode includes followings: a second list of candidate matching blocks for the current block is constructed based on template matching; and a first matching block is determined from the second list of candidate matching blocks. That is, in the IntraTMP fusion intra prediction method, the first matching block for the current block is determined in combination with the IntraTMP multi-candidate prediction mode, and a first prediction block for the current block is obtained according to the first matching block. In some embodiments, the operation that the first prediction block for the current block is obtained according to the first matching block includes followings: the first matching block is used as the first prediction block; or the first matching block is filtered to obtain the first prediction block.

In some embodiments, the operation that the first matching block is determined from the second list of candidate matching blocks includes following: first N matching blocks are determined from the second list of candidate matching blocks, herein N is an integer greater than 0.

In some embodiments, the operation that the first matching block is determined from the second list of candidate matching blocks further includes followings: first N matching blocks in the second list of candidate matching blocks are reordered; index values of the first N matching blocks are determined according to reordered positions of the first N matching blocks; and the first matching block is determined according to the index values of the first N matching blocks.

In some embodiments, the operation that the first N matching blocks in the second list of candidate matching blocks are reordered includes followings: a first prediction template of the current block is determined according to a template of an i-th matching block; a second prediction template of the current block is determined according to a non-template matching intra prediction mode used for the current block; the first prediction template and the second prediction template are fused to determine a final prediction template of the current block; a template error value corresponding to the i-th matching block is determined according to the final prediction template of the current block and a template of the current block; the first N matching blocks are reordered according to template error values corresponding to the first N matching blocks.

At step 1602, a second prediction block for the current block is determined based on a non-template matching intra prediction mode.

In some embodiments, the non-template matching intra prediction mode includes at least two candidate intra prediction modes. The method further includes following operations: the at least two candidate intra prediction modes are reordered to obtain a list of candidate intra prediction modes and an index value of each candidate intra prediction mode; an index value of a first intra prediction mode used for a current picture is determined; the first intra prediction mode is determined from the list of candidate intra prediction modes according to the index value of the first intra prediction mode; and the first intra prediction mode is used as the non-template matching intra prediction mode used for the current block.

In some embodiments, the operation that the at least two candidate intra prediction modes are reordered includes followings: a template of a matching block for the current block is used as a first prediction template of the current block; a second prediction template of the current block is determined according to the i-th candidate intra prediction mode; the first prediction template and the second prediction template are fused to determine a final prediction template of the current block; a template error value corresponding to the i-th candidate intra prediction mode is determined according to the final prediction template of the current block and a template of the current block; the at least two candidate intra prediction modes are reordered according to template error values corresponding to the at least two candidate intra prediction modes.

In some embodiments, an optimal intra prediction mode with the minimum template error value is determined as the first intra prediction mode.

At step 1603, the first prediction block and the second prediction block are fused to determine a final prediction block for the current block.

In some embodiments, the operation that the first prediction block and the second prediction block are fused to determine the final prediction block for the current block includes followings: the first prediction block and the second prediction block are fused according to a preset first weight value and a preset second weight value to determine the final prediction block of the current block.

In some embodiments, the operation that the first prediction block and the second prediction block are fused to determine the final prediction block for the current block includes following operations. The current block are partitioned into four sub-regions based on an intra prediction mode derived based on TIMD; first weight values and second weight values for the four sub-regions of the current block are determined, respectively; and the first prediction block and the second prediction block are fused according to the first weight values and the second weight values for the four sub-regions of the current block to determine the final prediction block for the current block. Alternatively, a first weight value and a second weight value for the current block are determined based on the intra prediction mode derived based on TIMD; and the first prediction block and the second prediction block are fused according to the first weight value and the second weight value for the current block to determine the final prediction block for the current block.

In some embodiments, when it is determined that the current block is predicted by using the IntraTMP multi-matching block fusion prediction mode, the operations further include followings: a first list of candidate matching blocks for the current block is constructed based on template matching; a first candidate matching block group is determined from the first list of candidate matching blocks; and at least one matching block in the first candidate matching block group is fused to determine a prediction block for the current block.

In some embodiments, the operation that the first candidate matching block group is determined from the first candidate matching block list includes following: the first N matching blocks in the first list of candidate matching blocks form the first candidate matching block group. N takes an integer greater than 0, for example, N is 3.

In some embodiments, when it is determined that the current block is predicted by using the IntraTMP multi-candidate prediction mode, the method includes following operations: a second list of candidate matching blocks for the current block is constructed based on template matching; a first matching block is determined from the second list of candidate matching blocks; and a prediction block for the current block is determined according to the first matching block.

In some embodiments, the operation that the prediction block for the current block is obtained according to the first matching block includes followings: the first matching block is used as the prediction block for the current block; and the matching block is filtered to obtain the prediction block for the current block.

At step 1604, it is determined whether the current block is predicted by using an IntraTMP fusion intra prediction mode by performing coding determination according to the final prediction block for the current block and an original block for the current block.

The encoding side and the decoding side use the same process to obtain the prediction block in each prediction mode. For example, a list of candidate matching blocks sorted in an ascending order according to template error values is constructed, and IntraTMP multi-matching block fusion prediction is performed to obtain a prediction block. It is tried to select a certain matching block from the list of candidate blocks, the filter coefficient is derived according to the template of the matching block and the template of the current block, and a filtered or unfiltered prediction block based on a single matching block is obtained; and the filtered or unfiltered prediction block is used to perform IntraTMP fusion intra prediction to determine the final prediction block for the current block. In some embodiments, the encoding side selects the optimal prediction mode by comparing distortion ratios (such as SAD or MSE or SATD or SSE) between the prediction blocks in a plurality of prediction modes and the original block, determines the value of the relevant syntax element according to the optimal prediction mode, encodes the relevant syntax element, signals the encoded bits in the bitstream, and completes the encoding process for the current block.

At step 1605, a relevant syntax element of the current block is encoded, and the obtained encoded bits are signalled in a bitstream.

The relevant syntax element is used for indicating whether the current block is predicted by using the IntraTMP fusion intra prediction mode.

It is to be noted that the relevant syntax element may be understood as indicating a prediction mode for the current block. Specifically, it is used for indicating an IntraTMP prediction mode, and more specifically, it is used for indicating whether the prediction mode for the current block is the IntraTMP fusion intra prediction mode.

In some embodiments, the relevant syntax element includes at least one of: a first syntax element or a second syntax element. Herein the first syntax element is used for indicating whether the IntraTMP fusion intra prediction mode is allowed to be used for predicting the current block; and the second syntax element is used for indicating whether the current block is predicted by using the IntraTMP fusion intra prediction mode.

In some embodiments, the relevant syntax element further includes at least one of: a syntax element for indicating whether an IntraTMP prediction mode is allowed to be used for predicting the current block; a syntax element for indicating whether the current block is predicted by using an IntraTMP prediction mode other than an IntraTMP fusion prediction mode; a syntax element for indicating whether the current block is predicted by using an IntraTMP fusion prediction mode other than the IntraTMP fusion intra prediction mode; a syntax element indicating whether the current block is predicted by using the IntraTMP multi-matching block fusion prediction mode; and a syntax element for indicating whether the current block is predicted by using the IntraTMP multi-candidate prediction mode. In practical applications, these syntax elements may be one or more of: block-level syntax elements, aslice-level syntax elements, tile-level syntax elements, picture-level syntax elements, or sequence-level syntax elements.

It is to be noted that the IntraTMP prediction mode refers to a prediction mode based on intra template matching, the IntraTMP fusion prediction mode may be understood as a fusion prediction mode based on intra template matching, and the IntraTMP fusion prediction mode includes the IntraTMP fusion intra prediction mode and other IntraTMP fusion prediction modes other than the IntraTMP fusion intra prediction mode. Exemplarily, other IntraTMP fusion prediction modes are any of prediction modes in which matching blocks obtained based on template matching participate in fusion, such as an IntraTMP multi-matching block fusion prediction mode, a combined intra-inter prediction mode, a template derived IntraTMP fusion, etc.

It is to be noted that a value of the first syntax element may be a first value or a second value, and each value of the first syntax element is used to indicate a specific meaning. Exemplarily, when the value of the first syntax element is the first value, it indicates that the IntraTMP fusion intra prediction mode is allowed to be used for predicting the current block. Alternatively, when the value of the first syntax element is the second value, it indicates that the IntraTMP fusion intra prediction mode is allowed to be used for predicting the current block. Exemplarily, the first value may be 1, and the second value may be 0.

In some examples, the first syntax element includes a block-level syntax element. In some embodiments, the first syntax element further includes at least one of: a slice-level syntax element, a tile-level syntax element, a picture-level syntax element, or a sequence-level syntax element.

In some examples, the second syntax element includes a block-level syntax element. In some embodiments, the second syntax element further includes at least one of: a slice-level syntax element, a tile-level syntax element, a picture-level syntax element, or a sequence-level syntax element.

In some embodiments, the operation that the relevant syntax element of the current block is encoded includes followings: the first syntax element is encoded; when the value of the first syntax element is the first value, it is determined that the IntraTMP fusion intra prediction mode is allowed to be used for predicting the current block, and the second syntax element is encoded; when a value of the second syntax element is a first value, it is determined that the current block is predicted by using the IntraTMP fusion intra prediction mode; and when the value of the second syntax element is a second value, it is determined that the current block is predicted by using the IntraTMP multi-matching block fusion prediction mode.

It is to be noted that it is determined that the IntraTMP fusion intra prediction mode is allowed to be used for predicting the current block, and further, the second syntax element is encoded, and it is determined whether the current block is predicted by using the IntraTMP fusion intra prediction mode or the IntraTMP multi-matching block fusion prediction mode according to the value of the second syntax element. The IntraTMP multi-matching block fusion prediction and the IntraTMP fusion intra prediction are regarded as two fusion prediction modes, and a block level flag bit is used for indicating which fusion prediction mode is used. Exemplarily, a relevant syntax element includes:

```
intra_tmp_flag
If( intra_tmp_flag)
{
  intra_tmp_fusion_flag
  If( intra_tmp_fusion_flag)
  {
    intra_tmp_intra_flag
  }
}
```

Here, intra_tmp_fusion_flag has a function of the first syntax element, intra_tmp_intra_flag has a function of the second syntax element, and intra_tmp_flag is used to indicate that the IntraTMP prediction mode is allowed to be used for predicting the current block. An IntraTMP related syntax element is encoded. If intra_tmp_flag is true, it indicates that an IntraTMP prediction mode is used for the current block, and then intra_tmp_fusion_flag is encoded. If intra_tmp_fusion_flag is true, it indicates that the IntraTMP fusion intra prediction mode is allowed to be used for predicting the current block, and further intra_tmp_intra_flag is encoded. If intra_tmp_intra_flag is true, it indicates that the IntraTMP fusion intra prediction mode is used, if intra_tmp_intra_flagis false, it indicates that the IntraTMP multi-matching block fusion mode is used.

In some embodiments, the operation that the relevant syntax element of the current block is encoded includes followings: the first syntax element is encoded; when the value of the first syntax element is the first value, it is determined that the IntraTMP fusion intra prediction mode is allowed to be used for predicting the current block, and the second syntax element is encoded; when the value of the second syntax element is the first value, it is determined that the current block is predicted by using the IntraTMP fusion intra prediction mode; and when the value of the second syntax element is the second value, it is determined that the current block is predicted by using an IntraTMP multi-candidate prediction mode.

It is to be noted that it is determined that the IntraTMP fusion intra prediction mode is allowed to be used for predicting the current block, and further, the second syntax element is encoded, and it is determined whether the current block is predicted by using the IntraTMP fusion intra prediction mode or the IntraTMP multi-candidate prediction mode according to the value of the second syntax element. The IntraTMP multi-candidate prediction mode may be understood as an IntraTMP prediction mode based on a single matching block. IntraTMP multi-matching block fusion prediction and IntraTMP fusion intra prediction are regarded as two fusion prediction modes, and the IntraTMP multi-candidate prediction mode is an extension for the IntraTMP fusion intra prediction mode, in which a block level flag bit is used for indicating whether a selected matching block is fused with the second prediction block obtained by the intra prediction mode. Further, the selected first matching block may be indicated by an index value.

In some embodiments, the operation that the relevant syntax element of the current block is encoded includes: when the value of the first syntax element is the first value, it is determined that the current block is predicted by using the IntraTMP multi-matching block fusion prediction mode; when the value of the first syntax element is the second value, it is determined that the IntraTMP fusion intra prediction mode is allowed to be used for predicting the current block, and the second syntax element is encoded; the value of the second syntax element being the first value indicates that the current block is predicted by using the IntraTMP fusion intra prediction mode; and the value of the second syntax element being the second value indicates that the current block is predicted by using the IntraTMP multi-candidate prediction mode.

It is to be noted that when the value of the first syntax element is the first value, it is determined that the current block is predicted by using the IntraTMP multi-matching block fusion prediction mode, that is, it is determined that the IntraTMP fusion intra prediction mode is not allowed to be used for predicting the current block, and the first syntax element is used to indicate whether the current block is predicted by using the IntraTMP multi-matching block fusion prediction mode in addition to indicating whether the IntraTMP fusion intra prediction mode is allowed to be used for predicting the current block. The IntraTMP multi-matching block fusion prediction mode, the IntraTMP multi-candidate prediction mode and the IntraTMP fusion intra prediction mode are used as three prediction modes, and the block level flag bit is used for indicating which prediction mode is selected, and for indicating whether the selected matching block is fused with the second prediction block obtained by the intra prediction mode.

Exemplarily, a relevant syntax element includes:

```
intra_tmp_flag
If( intra_tmp_flag)
{
  intra_tmp_fusion_flag
  If(! intra_tmp_fusion_flag)
  {
    intra_tmp_intra_flag
  }
}
```

If intra_tmp_flag is true, it indicates that the IntraTMP prediction mode is used for the current block, and then intra_tmp_fusion_flag is encoded. If intra_tmp_fusion_flag is true, it indicates that the IntraTMP multi-matching block fusion mode is used for the current block. If intra_tmp_fusion_flag is false, it indicates that the prediction mode based on a single matching block is used for the coding block, or it may also indicate that the IntraTMP fusion intra prediction mode is allowed to be used for predicting the current block, and the intra_tmp_intra_flag is further encoded. If intra_tmp_intra_flag is true, it indicates that the IntraTMP fusion intra prediction mode is used, and if intra_tmp_intra_flag is false, it indicates that the prediction mode based on a single matching block is used, that is, the IntraTMP multi-candidate prediction mode is used.

In some embodiments, the foregoing prediction modes may also be fused with an IntraTMP filtering technique. For example, the relevant syntax element further includes a third syntax element. In some embodiments, the method further includes following operations: the third syntax element is encoded, herein the third syntax element is used for indicating whether to filter the first matching block or whether to filter a prediction block for the current block. Exemplarily, if a value of the third syntax element is a first value, it is determined to filter the first matching block or to filter the prediction block for the current block; if the value of the third syntax element is a second value, it is determined not to filter the first matching block or not to filter the prediction block for the current block.

In some embodiments, the second syntax element and the third syntax element are encoded.

In some embodiments, it is determined that he IntraTMP fusion intra prediction mode is allowed to be used for predicting the current block, and the third syntax element is encoded. In some embodiments, it is determined that the current block is predicted by using the IntraTMP multi-candidate prediction mode, and the third syntax element is encoded.

It is to be noted that the first matching block is a first matching block determined based on the template matching prediction mode. The operation of filtering the first matching block or the prediction block for the current block may be pre-agreed. Alternatively, two syntax elements are used for indicating whether to filter the first matching block and whether to filter the prediction block for the current block, respectively. Alternatively, only one of them is configured with the syntax element, and the other one is pre-determined.

Exemplarily, a relevant syntax element includes:

```
intra_tmp_flag
If( intra_tmp_flag)
{
intra_tmp_fusion_flag
  If( intra_tmp_fusion_flag)
  {
    intra_tmp_intra_flag
    intra_tmp_filter_flag
  }
}
or
intra_tmp_flag
If( intra_tmp_flag)
{
intra_tmp_fusion_flag
  If(! intra_tmp_fusion_flag)
  {
    intra_tmp_intra_flag
    intra_tmp_filter_flag
  }
}
```

On the basis of the above embodiments, if it is determined that the IntraTMP fusion intra prediction mode is allowed to be used for predicting the current block, intra_tmp_filter_flag is encoded. If intra_tmp_filter_flag is true, it indicates that the selected matching block is filtered, and if intra_tmp_filter_flag is false, it indicates that the selected matching block is not filtered. It is to be noted that if intra_tmp_intra_flag is true, it indicates that the IntraTMP fusion intra prediction mode is used, and the selected first matching block is used for fusion intra prediction, and if intra_tmp_intra_flag is false, it indicates that the selected matching block is not fused with the intra prediction block, and it indicates that the prediction mode based on a single matching block is used, that is, the IntraTMP multi-candidate prediction mode is used.

In some embodiments, the index information may also be transmitted to indicate which matching block in the list of candidate matching blocks is to be used for fusion. The method further includes following operations: it is determined that the IntraTMP fusion intra prediction mode is allowed to be used for predicting the current block, and a fourth syntax element is encoded. Herein the fourth syntax element is used for indicating an index value of a first matching block in the list of candidate matching blocks; or the fourth syntax element is used for indicating an index value of a first candidate matching block group in the list of candidate matching blocks.

Exemplarily, a relevant syntax element includes:

```
intra_tmp_flag
If( intra_tmp_flag)
{
  intra_tmp_fusion_flag
  If( intra_tmp_fusion_flag){
    intra_tmp_intra_flag
    intra_tmp_intra_idx
  }
}
```

If intra_tmp_intra_flag is true, it indicates that the IntraTMP fusion intra prediction mode is used, and intra_tmp_intra_idx indicates which matching block is fused with the intra prediction block. If intra_tmp_intra_flag is false, it indicates that the IntraTMP multi-matching block fusion mode is used, and intra_tmp_intra_idx indicates which candidate matching block group in the list of candidate matching blocks is used for the multi-matching block fusion. Intra_tmp_intra_idx may also be referred to as intra_tmp_fusion_idx. Exemplarily, a relevant syntax element includes:

```
intra_tmp_flag
If( intra_tmp_flag){
  intra_tmp_fusion_flag
  If(! intra_tmp_fusion_flag){
    intra_tmp_intra_flag
    intra_tmp_intra_idx
  }
}
```

If intra_tmp_intra_flag is true, it indicates that the IntraTMP fusion intra prediction mode is used, and intra_tmp_intra_idx indicates which matching block is fused with the intra prediction block. If intra_tmp_intra_flag is false, it indicates that the IntraTMP multi-candidate prediction mode is used, and intra_tmp_intra_idx indicates which matching block is used for predicting.

In some embodiments, the first syntax element and fourth syntax element are encoded. The fourth syntax element is used for indicating the index value of a first matching block in the list of candidate matching blocks; or the fourth syntax element is used for indicating the index value of the first candidate matching block group in the list of candidate matching blocks.

In some embodiments, when the value of the first syntax element is the first value, it is determined that the current block is predicted by using the IntraTMP multi-matching block fusion prediction mode, and the index value of the first candidate matching block group is determined according to the fourth syntax element. When the value of the first syntax element is the second value, it is determined that the IntraTMP fusion intra prediction mode is allowed to be used for predicting the current block, and the second syntax element is encoded. When the value of the second syntax element is the first value, it is determined that the current block is predicted by using the IntraTMP fusion intra prediction mode. In some embodiments, the index value of the first matching block is determined according to the fourth syntax element. When the value of the second syntax element is the second value, it is determined that the current block is predicted by using the IntraTMP multi-candidate prediction mode. In some embodiments, the index value of the first matching block is determined according to the fourth syntax element.

Exemplarily, a relevant syntax element includes:

```
intra_tmp_flag
If( intra_tmp_flag){
  intra_tmp_fusion_flag
  intra_tmp_fusion_idx
  If(! intra_tmp_fusion_flag){
    intra_tmp_intra_flag
  }
}
```

If intra_tmp_flag is true, it indicates that the IntraTMP prediction mode is used for the current block, then intra_tmp_fusion_flag is encoded. If intra_tmp_fusion_flag is true, it indicates that the IntraTMP multi-matching block fusion mode is used for the current block, intra_tmp_fusion_idx indicates which candidate matching block group in the list of candidate matching blocks is used for performing the multi-matching block fusion. If intra_tmp_fusion_flag is false, it indicates that the prediction mode based on a single matching block is used for the coding block, or it may also indicate that the IntraTMP fusion intra prediction mode is allowed to be used for predicting the current block, and the intra_tmp_intra_flag is further encoded. If intra_tmp_intra_flag is true, it indicates that the IntraTMP fusion intra prediction mode is used, and intra_tmp_fusion_idx indicates which matching block is fused with the intra prediction block. If intra_tmp_intra_flag is false, it indicates that the prediction mode based on a single matching block is used, that is, the IntraTMP multi-candidate prediction mode is used, and intra_tmp_intra_idx indicates which matching block is used for predicting. For example, if intra_tmp_idx is equal to i, the (i+1)-th matching block in the list of candidate matching blocks is the selected matching block, the value of i starts from 0, and the index value starts from 1. Alternatively, if intra_tmp_idx is equal to i, the i-th matching block in the list of candidate matching blocks is the selected matching block, the value of i starts from 0, and the index value also starts from 0.

In some embodiments, the foregoing prediction modes may also be fused with IntraTMP filtering technique. Exemplarily, a relevant syntax element includes:

```
intra_tmp_flag
If( intra_tmp_flag)
{
intra_tmp_fusion_flag
  If( intra_tmp_fusion_flag)
  {
    intra_tmp_intra_flag
    intra_tmp_filter_flag
    intra_tmp_idx
  }
}
```

The IntraTMP related syntax element is encoded. If intra_tmp_flag is true, it indicates that the coding block is encoded by using the IntraTMP mode, and then intra_tmp_fusion_flag is encoded. If intra_tmp_fusion_flag is true, it is determined that the IntraTMP fusion intra prediction mode is used, and intra_tmp_intra_flag, intra_tmp_filter_flag and intra_tmp_idx (the sequence may be switched) are further encoded. The intra_tmp_idx represents an index of the selected matching block in the list of candidate matching blocks. If intra_tmp_filter_flag is true, it indicates that the selected matching block is filtered, and if intra_tmp_filter_flag is false, it indicates that the selected matching block is not filtered. If intra_tmp_intra_flag is true, it indicates that the selected matching block is fused with the intra prediction block, and if intra_tmp_intra_flag is false, it indicates that the selected matching block is not fused with the intra prediction block.

```
intra_tmp_flag
If( intra_tmp_flag)
{
intra_tmp_fusion_flag
  If(! intra_tmp_fusion_flag)
  {
    intra_tmp_intra_flag
    intra_tmp_filter_flag
    intra_tmp_idx
  }
}
```

The IntraTMP related syntax element is encoded. If intra_tmp_flag is true, it indicates that the coding block is encoded by using the IntraTMP mode, and further intra_tmp_fusion_flag is encoded. If intra_tmp_fusion_flag is true, it indicates that the coding block is predicted by using the multi-matching block fusion mode. If intra_tmp_fusion_flag is false, it indicates that a prediction method based on a single matching block is used for the coding block, or it may also be understood as that it is determined that the IntraTMP fusion intra prediction mode is allowed to be used for predicting the current block, and further intra_tmp_intra_flag, intra_tmp_filter_flag and intra_tmp_idx (the sequence may be switched) are encoded. The intra_tmp_idx represents an index of the selected matching block in the list of candidate matching blocks. If intra_tmp_filter_flag is true, it indicates that the selected matching block is filtered, and if intra_tmp_filter_flag is false, it indicates that the selected matching block is not filtered. If intra_tmp_intra_flag is true, it indicates that the selected matching block is fused with the intra prediction block, if intra_tmp_intra_flag is false, it indicates that the selected matching block is not fused with the intra prediction block.

In some embodiments, intra_tmp_intra_idx and intra_tmp_fusion_idx may also be encoded in different ways according to intra_tmp_intra_flag. For example, the method further includes following operations: it is determined that the current block is predicted by using the IntraTMP fusion intra prediction mode, and the fourth syntax element is encoded; and the index value of the first matching block in the list of candidate matching blocks is determined according to the fourth syntax element; or it is determined that the current block is predicted by using the IntraTMP multi-matching block fusion prediction mode, and a fifth syntax element is encoded; and the index value of the first candidate matching block group in the list of candidate matching blocks is determined according to the fifth syntax element.

Exemplarily, a relevant syntax element includes:

```
intra_tmp_flag
If( intra_tmp_flag)
{
  intra_tmp_fusion_flag
  If( intra_tmp_fusion_flag) {
    intra_tmp_intra_flag
    intra_tmp_filter_flag
    if( intra_tmp_intra_flag)
      intra_tmp_intra_idx
    else
      intra_tmp_fusion_idx
  }
}
or
intra_tmp_flag
If( intra_tmp_flag)
{
  intra_tmp_fusion_flag
  If(! intra_tmp_fusion_flag)
  {
    intra_tmp_intra_flag
    intra_tmp_filter_flag
    if( intra_tmp_intra_flag)
      intra_tmp_intra_idx
  }
  else
  intra_tmp_fusion_idx
}
```

On the basis of the above embodiments, if it is determined that the current block is predicted by using the IntraTMP fusion intra prediction mode, intra_tmp_intra_idx (fourth syntax element) is encoded, and it represents the index value of the selected matching block in the list of candidate matching blocks. If it is determined that the IntraTMP multi-matching block fusion prediction mode is used, intra_tmp_fusion_idx (the fifth syntax element) is encoded, and intra_tmp_fusion_idx represents the index value of the selected first candidate matching block group in the list of candidate matching blocks. A value range of intra_tmp_intra_idx may be the same as or different from a value range of intr_tmp_fusion_idx.

In some embodiments, intra_tmp_intra_idx and intra_tmp_idx may also be encoded in different ways according to intra_tmp_intra_flag. The method further includes following operations. It is determined that the current block is predicted by using the IntraTMP fusion intra prediction mode, and the fourth syntax element is encoded; and the index value of the first matching block in the list of candidate matching blocks is determined according to the fourth syntax element. Alternatively, it is determined that the current block is predicted by using the IntraTMP multi-candidate prediction mode, and a sixth syntax element is encoded; and the index value of the first matching block in the list of candidate matching blocks is determined according to the sixth syntax element.

Exemplarily, a relevant syntax element includes:

```
intra_tmp_flag
If( intra_tmp_flag)
{
intra_tmp_fusion_flag
  If( ! intra_tmp_fusion_flag){
    intra_tmp_intra_flag
    intra_tmp_filter_flag
    If (intra_tmp_intra_flag)
      intra_tmp_intra_idx
    else
      intra_tmp_idx
  }
}
```

On the basis of the above embodiments, if it is determined that the current block is predicted by using the IntraTMP fusion intra prediction mode, intra_tmp_intra_idx (the fourth syntax element) is encoded, and intra_tmp_intra_idx represents the index value of the selected matching block in the list of candidate matching blocks. If it is determined that the IntraTMP multi-candidate prediction mode is used, intra_tmp_idx (the sixth syntax element) is encoded, and intra_tmp_idx represents the index value of the selected matching block in the list of candidate matching blocks. The value range of intra_tmp_intra_idx may be the same as or different from the value range of the value range of intr_tmp_idx. For example, the maximum value of the value range of intra_tmp_intra_idx is smaller than the maximum value of the value range of intra_tmp_idx, the value range of intra_tmp_intra_idx is 0-3, and the value range of intra_tmp_idx is 0-15.

In some embodiments, IntraTMP fusion intra prediction and IntraTMP filtering may not be used together. Exemplarily, the operation of that it is determined that the current block is predicted by using the IntraTMP fusion intra prediction mode includes followings: it is determined not to filter the first matching block or not to filter the prediction block for the current block, and the second syntax element is encoded. When the value of the second syntax element is the first value, it is determined that the current block is predicted by using the IntraTMP fusion intra prediction mode.

Further, the method further includes following operation: the fourth syntax element is encoded. The fourth syntax element is used for indicating the index value of the first matching block in the list of candidate matching blocks.

Exemplarily, a relevant syntax element includes:

```
intra_tmp_flag
If( intra_tmp_flag)
{
intra_tmp_fusion_flag
  If( ! intra_tmp_fusion_flag){
    intra_tmp_filter_flag
    If( !intra_tmp_filter_flag)
      intra_tmp_intra_flag
    intra_tmp_idx
  }
}
```

On the basis of the above embodiments, if it is determined that the IntraTMP fusion intra prediction mode is allowed to be used for predicting the current block, intra_tmp_filter_flag (the third syntax element) is encoded. If intra_tmp_filter_flag is false, it indicates that a single matching block is not filtered, intra_tmp_intra_flag (the second syntax element) is encoded, and intra_tmp_idx (the fourth syntax element) is further encoded to determine the selected matching block. If intra_tmp_filter_flag is true, it indicates that a single matching block is filtered, and intra_tmp_idx is encoded to determine the selected matching block. In some embodiments, if intra_tmp_filter_flag is true, it may also indicate that prediction is performed by using the IntraTMP multi-candidate prediction mode. That is, it is determined whether or not to encode intra_tmp_intra_flag according to the value of intra_tmp_filter_flag.

In some embodiments, IntraTMP fusion intra prediction and IntraTMP filtering may not be used together. The method further includes following operations: it is determined that the current block is predicted by using the IntraTMP multi-candidate prediction mode, and the third syntax element is encoded. Herein the third syntax element is used for indicating whether to filter a first matching block.

Further, the method further includes following operations: the fourth syntax element is encoded. The fourth syntax element is used for indicating the index value of the first matching block in the list of candidate matching blocks.

Exemplarily, a relevant syntax element includes:

```
intra_tmp_flag
If( intra_tmp_flag)
{
  intra_tmp_fusion_flag
  If(! intra_tmp_fusion_flag)
  {
    intra_tmp_intra_flag
    If( !intra_tmp_intra_flag)
      intra_tmp_filter_flag
    intra_tmp_idx
  }
}
```

On the basis of the above embodiments, if it is determined that the IntraTMP fusion intra prediction mode is allowed to be used for predicting the current block, intra_tmp_intra_flag (the second syntax element) is encoded. If intra_tmp_intra_flag is false, it indicates that the IntraTMP multi-candidate prediction mode is used for predicting, and intra_tmp_filter_flag (the third syntax element) is encoded to determine whether to filter a single matching block, and intra_tmp_idx (the fourth syntax element) is further encoded to determine the selected matching block. If intra_tmp_intra_flag is true, it indicates that prediction is performed by using the IntraTMP fusion intra prediction mode, and intra_tmp_idx (the fourth syntax element) is further encoded to determine the selected matching block. That is, it is determined whether or not to encode intra_tmp_filter_flag according to the value of intra_tmp_intra_flag.

In some embodiments, a plurality of intra prediction modes may also be set, a particular intra prediction mode is indicated by transmitting a syntax element. The method further includes following operations: it is determined that the current block is predicted by using the IntraTMP fusion intra prediction mode and a seventh syntax element is encoded. The seventh syntax element is used for indicating a non-template matching intra prediction mode used for the current block.

Exemplarily, a relevant syntax element includes:

```
intra_tmp_flag
If( intra_tmp_flag)
{
  intra_tmp_fusion_flag
  If( intra_tmp_fusion_flag){
    intra_tmp_intra_flag
    If( intra_tmp_intra_flag)
      intra_tmp_intra_mode_idx
    }
}
or
intra_tmp_flag
If( intra_tmp_flag)
{
  intra_tmp_fusion_flag
  If( ! intra_tmp_fusion_flag){
    intra_tmp_intra_flag
    intra_tmp_filter_flag
    If (intra_tmp_intra_flag) {
      intra_tmp_intra_idx
      intra_tmp_intra_mode_idx
    }
    else
      intra_tmp_idx
  }
}
```

In the IntraTMP fusion intra prediction mode, a plurality of intra prediction modes may be set, such as a predefined intra prediction mode, an intra prediction mode from a matching block, and an intra prediction mode derived by a method such as TIMD or DIMD, and an intra prediction mode may be selected by signalling an index. On the basis of the above embodiments, if it is determined that the current block is predicted by using the IntraTMP fusion intra prediction mode, that is, intra_tmp_intra_flag is true, the seventh syntax element (intra_tmp_intra_mode_idx) is encoded, and an intra prediction mode is determined according to intra_tmp_intra_mode_idx, for determining the second prediction block.

In some embodiments, the relevant syntax element includes the first syntax element (intra_tmp_fusion_flag), and the method further includes following operations: when a value of the first syntax element is a first value, it is determined that the IntraTMP fusion intra prediction mode is allowed to be used for predicting the current block; a first prediction template of the current block is determined by predicting in a template region of the current block by using the IntraTMP fusion intra prediction mode; a first template error value is determined according to the first prediction template and a template of the current block; a second prediction template of the current block is determined by predicting in the template region of the current block by using a first IntraTMP prediction mode; a second template error value is determined according to the second prediction template and the template of the current block; when a minimum template error value is the first template error value, it is determined that the current block is predicted by using the IntraTMP fusion intra prediction mode; and when the minimum template error value is the second template error value, it is determined that the current block is predicted by using the first IntraTMP prediction mode. The first IntraTMP prediction mode includes at least one of an IntraTMP multi-matching block fusion prediction mode or an IntraTMP multi-candidate prediction mode.

That is, when intra_tmp_fusion_flag is true, it is not necessary to encode intra_tmp_intra_flag. According to at least one of the template error value for the multi-matching block fusion prediction in the template region or the template error value for the multi-candidate prediction in the template region, and the template error value for the fusion intra prediction in the template region, the prediction mode to be used is selected.

In some embodiments, the method further includes following operations: an eighth syntax element is encoded. Herein the eighth syntax element is used for indicating whether to encode part or all of syntax elements in the relevant syntax element of the current block. In some embodiments, the eighth syntax element includes at least one of: a sequence-level syntax element, a picture-level syntax element, a tile-level syntax element, a slice-level syntax element, or a block-level syntax element.

It is to be noted that part or all of syntax elements in the relevant syntax elements may be controlled by one or more of the block-level syntax element, the slice-level syntax element, the tile-level syntax element, the picture-level syntax element and the sequence-level syntax element. That is, a corresponding eighth syntax element may be set for each of the syntax elements in the relevant syntax elements, or a corresponding eighth syntax element may be set for two or more of the syntax elements in the relevant syntax element, or a corresponding eighth syntax element may be set for all syntax elements in the relevant syntax elements. For example, when the relevant syntax element is a block-level syntax element, the sixth syntax element may be a picture-level and/or sequence-level syntax element.

By using the above technical solutions, the encoding side determines whether the current block is predicted by using the IntraTMP fusion intra prediction mode and encodes the relevant syntax element, thereby improving the prediction efficiency at the decoding side. Meanwhile the IntraTMP fusion intra prediction mode combines IntraTMP technologies such as IntraTMP multi-candidate, IntraTMP multi-matching block fusion and IntraTMP filtering to adapt to more encoding/decoding scenarios, thereby ensuring prediction accuracy and the efficiency of encoding/decoding.

Further, a bitstream is provided in an embodiment of the present disclosure. The bitstream is generated by bit encoding according to information to be encoded. The information to be encoded includes at least one of: a syntax element for indicating whether an IntraTMP fusion intra prediction mode is allowed to be used for predicting a current block; a syntax element for indicating whether the current block is predicted by using the IntraTMP fusion intra prediction mode; a syntax element for indicating whether to filter a first matching block; a syntax element for indicating filtering a prediction block for the current block; a syntax element for indicating an index value of a first matching block in a list of candidate matching blocks; a syntax element for indicating an index value of a first matching block group in the list of candidate matching blocks; a syntax element for indicating a non-template matching intra prediction mode; a syntax element for indicating whether to decode a relevant syntax element of the current block; a number of matching blocks in a candidate matching block group; a value N of a number of matching blocks in a case of multi-matching block fusion; a length of a first list of candidate matching blocks; or a length of a second list of candidate matching blocks.

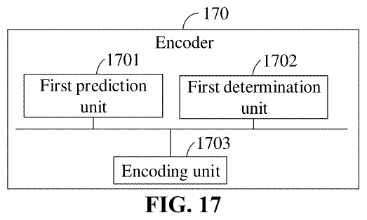

In another embodiment of the present disclosure, on the basis of the same inventive concept of the foregoing embodiments, referring to FIG. 17, FIG. 17 illustrates a schematic diagram of the configuration structure of an encoder according to an embodiment of the present disclosure. As illustrated in FIG. 17, the encoder 170 may include: a first prediction unit 1701, a first determination unit 1702 and an encoding unit 1703.

The first prediction unit 1701 is configured to: determine a matching block for the current block based on a template matching prediction mode, and determine a first prediction block for the current block according to the matching block.

The first prediction unit 1701 is configured to determine a second prediction block for the current block based on a non-template matching intra prediction mode.

The first prediction unit 1701 is configured to fuse the first prediction block and the second prediction block to determine a final prediction block for the current block.

The first determination unit 1702 is configured to determine whether the current block is predicted by using an IntraTMP fusion intra prediction mode by performing coding determination according to the final prediction block for the current block and an original block for the current block.

The encoding unit 1703 is configured to: encode a relevant syntax element of the current block, and signal obtained encoded bits in a bitstream.

The relevant syntax element is used for indicating whether the current block is predicted by using the IntraTMP fusion intra prediction mode.

It may be understood that the functional units of the encoder also perform the encoding method described in any one of the foregoing embodiments.

It is to be understood that in the embodiments of the present disclosure, the “unit” may be a part of a circuit, a part of a processor, part of programs or softwares, etc., or, it may also be modular or non-modular. Further, in the embodiments, various functional units may be integrated in one processing unit, or each unit may exist physically alone, or two or more units may be integrated in one unit. The above-mentioned integrated unit may be implemented either in the form of hardware or in the form of software function module.

When the integrated unit is implemented in the form of a software function module and does not be sold or used as an independent product, it may also be stored in a computer-readable storage medium. Based on such understanding, the technical solution of the present embodiments in essence or the part contributing to the related art or all or part of the technical solutions may be embodied in the form of software product, and the software product is stored in a storage medium and includes several instructions for enabling a computer device (which can be a personal computer, a server, a network device, etc.) or processor to perform all or part of the operations of the method of the present embodiments. The aforementioned storage media include: a U disk, a mobile hard disk, a read-only memory (ROM), a random access memory (RAM), a disk or an optical disk and other media that can store program codes.

Therefore, the embodiments of the present disclosure provide a computer readable storage medium, applied to the encoder 170. The computer readable storage medium stores thereon s computer program which, when implemented by a first processor, implement the encoding method of any one of the preceding embodiments.

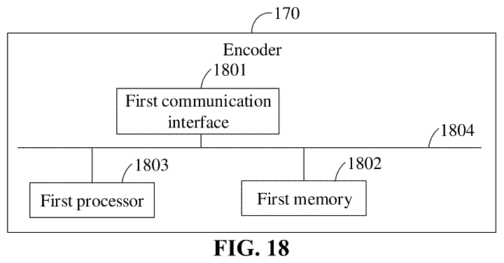

Based on the configuration of the encoder 170 and the computer readable storage medium, referring to FIG. 18, FIG. 18 illustrates a schematic structural diagram of a specific hardware of an encoder 170 provided by an embodiment of the present disclosure. As illustrated in FIG. 18, the encoder 170 may include: a first communication interface 1801, a first memory 1802 and a first processor 1803. The components are coupled together via a first bus system 1804. It is to be understood that the first bus system 1804 is used to implement the connection communication between these components. In addition to a data bus, the first bus system 1804 further includes a power bus, a control bus and a status signal bus. However, the various buses are marked as the first bus system 1804 in FIG. 18 for the purpose of clarity.

The first communication interface 1801 is configured to receive/transmit the signal in the process of transmitting/receiving information to/from other external network elements.

The first memory 1802 is configured to store a computer program executable on the first processor 1803.

The first processor 1803 is configured to execute the computer program to:
determine a matching block for the current block based on a template matching prediction mode, and determine a first prediction block for the current block according to the matching block;
determine a second prediction block for the current block based on a non-template matching intra prediction mode;
fuse the first prediction block and the second prediction block to determine a final prediction block for the current block;
determine whether the current block is predicted by using an intra template matching prediction (IntraTMP) fusion intra prediction mode by performing coding determination according to the final prediction block for the current block and an original block for the current block; and
encode a relevant syntax element of the current block, and signal obtained encoded bits in a bitstream.

The relevant syntax element is used for indicating whether the current block is predicted by using the IntraTMP fusion intra prediction mode.

It is to be understood that the first memory 1802 in the embodiments of the present disclosure may be a volatile memory or a non-volatile memory, or may include both s volatile and a non-volatile memory. The nonvolatile memory can be a read-only memory (ROM), programmable ROM (PROM), an erasable Prom (EPROM), an electrically erasable EPROM (EEPROM) or a flash memory. The volatile memory can be a random access memory (RAM), which is used as an external cache. By way of exemplary illustration, but not limitation, many forms of RAM are available, such as a static RAM (SRAM), a dynamic RAM (DRAM), a synchronous DRAM (SDRAM), a double data rate SDRAM (DDRSDRAM, enhanced SDRAM (ESDRAM), a synchlink DRAM (SLDRAM) and a direct Rambus RAM (DR RAM). The first memory 1802 of the systems and methods described herein is intended to include, but is not limited to, these and any other suitable types of memories.

The first processor 1803 may be an integrated circuit chip, which has signal processing capability. During the implementation, the various steps of the above method may be implemented by the integrated logic circuit of hardware in the first processor 1803 or instructions in the form of software. The above first processor 1803 may be general purpose processors, digital signal processors (DSPs), application specific integrated circuits (ASICs), field programmable gate arrays (FPGAs) or other programmable logic devices, discrete gate or transistor logic devices, and discrete hardware components. The disclosed methods, operations and logic block diagrams in the embodiments of the present disclosure can be implemented or executed. The general-purpose processor may be a microprocessor or the processor may be any conventional processor or the like. The operations of the methods disclosed in connection with the embodiments of the present disclosure can be directly embodied in the execution completion of the hardware decoding processor, or by the combination of the hardware and software modules in the decoding processor. The software module can be located in a random memory, a flash memory, a read-only memory, a programmable read-only memory or an electrically erasable programmable memory, a register and other mature storage media in the art. The storage medium is located in the first memory 1802, and the first processor 1803 reads the information in the first memory 1802 to complete the operations of the above methods in combination with its hardware.

It is to be understood that the embodiments described herein may be implemented in hardware, software, firmware, middleware, microcode or a combination thereof. For the hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general purpose processors, controllers, microcontrollers, microprocessors, other electronic units for performing the functions described herein, or a combination thereof. For the software implementation, the techniques described herein may be implemented by modules (e.g. procedures, functions, etc.) that perform the functions described herein. The software code may be stored in the memory and executed by a processor. The memory may be implemented in the processor or outside the processor.

Alternatively, as another embodiment, the first processor 1803 is further configured to execute the computer program to perform the encoding method of any of the preceding embodiments.

The present embodiment provides an encoder. For the encoder, by constructing a list of candidate matching blocks and grouping the list of candidate matching blocks, transmitting an index value to indicate the first candidate matching block group, and using the first candidate matching block group to perform fusion prediction, the prediction accuracy may be improved, and the bit rate may be saved, meanwhile the encoding/decoding efficiency may also be improved, thereby improving the encoding/decoding performance. Further, by limiting the range of the index value of the candidate matching block group, the codeword for coding the index value is saved, and the coding efficiency is improved. For example, the index value is controlled to a smaller index range by reordering the candidate matching block groups.

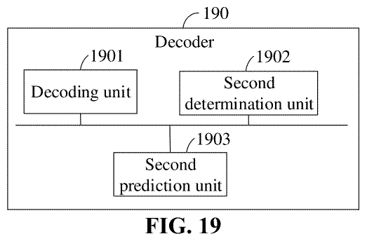

In another embodiment of the present disclosure, on the basis of the same inventive concept of the foregoing embodiments, referring to FIG. 19, FIG. 19 illustrates a schematic diagram of the configuration structure of a decoder 190 according to an embodiment of the present disclosure. As illustrated in FIG. 19, the decoder 190 may include: a decoding unit 1901, a second determination unit 1902 and a second prediction unit 1903.

The decoding unit 1901 is configured to decode a relevant syntax element of a current block, the relevant syntax element is used for indicating whether the current block is predicted by using an IntraTMP fusion intra prediction mode.

The second determination unit 1902 is configured to determine that the current block is predicted by using the IntraTMP fusion intra prediction mode according to the relevant syntax element.

The second prediction unit 1903 is configured to: determine a matching block for the current block based on a template matching prediction mode, and determine a first prediction block for the current block according to the matching block.

The second prediction unit 1903 is further configured to determine a second prediction block for the current block based on a non-template matching intra prediction mode.

The second prediction unit 1903 is further configured to fuse the first prediction block and the second prediction block to determine a final prediction block for the current block.

It is to be understood that the functional units of the decoder also perform the decoding method described in any one of the foregoing embodiments.

It is to be understood that in the embodiments, the “unit” may be a part of a circuit, part of a processor, part of programs or softwares, etc., or, it may also be modular or non-modular. Further, in the embodiments, various functional units may be integrated in one processing unit, or each unit may exist physically alone, or two or more units may be integrated in one unit. The above-mentioned integrated unit may be implemented either in the form of hardware or in the form of software function module.

When the integrated unit is implemented in the form of a software function module and does not be sold or used as an independent product, it may also be stored in a computer-readable storage medium. Based on such understanding, the embodiments of the present disclosure provide a computer readable storage medium, applied to the decoder 190. The computer readable storage medium stores a computer program which, when implemented by a second processor, implement the decoding method of any one of the preceding embodiments.

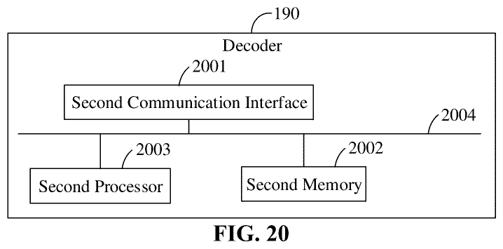

Based on the configuration of the decoder 190 and the computer readable storage medium, referring to FIG. 20, FIG. 20 illustrates a schematic structural diagram of a specific hardware of a decoder 190 provided by an embodiment of the present disclosure. As illustrated in FIG. 20, the decoder 190 may include a second communication interface 2001, a second memory 2002 and a second processor 2003. These components are coupled together via a second bus system 2004. It is to be understood that the second bus system 2004 is used to implement the connection communication between these components. In addition to a data bus, the second bus system 2004 further includes a power bus, a control bus and a status signal bus. However, the various buses are marked as the second bus system 2004 in FIG. 20 for the purpose of clarity.

The second communication interface 2001 is configured to receive/transmit the signal in the process of transmitting/receiving information to/from other external network elements.

The second memory 2002 is configured to store a computer program executable on the second processor 2003.

The second processor 2003 is configured to execute the computer program to:
determine a matching block for a current block based on a template matching prediction mode, and determine a first prediction block for the current block according to the matching block;
determine a second prediction block for the current block based on a non-template matching intra prediction mode;
fuse the first prediction block and the second prediction block to determine a final prediction block for the current block;
determine whether the current block is predicted by using an intra template matching prediction (IntraTMP) fusion intra prediction mode by performing coding determination according to the final prediction block for the current block and an original block for the current block; and
encode a relevant syntax element of the current block, and signal obtained encoded bits in a bitstream, the relevant syntax element is used for indicating whether the current block is predicted by using the IntraTMP fusion intra prediction mode.

Alternatively, as another embodiment, the second processor 2003 is further configured to execute the computer program to perform the decoding method of any of the preceding embodiments.

It is to be understood that the second memory 2002 is similar in hardware function to the first memory 1802, and the second processor 2003 is similar in hardware function to the first processor 1803, and will not be elaborated here.

The present embodiment provides a decoder. For the decoder, by constructing a list of candidate matching blocks and grouping the list of candidate matching blocks, transmitting an index value to indicate the first candidate matching block group, and using the first candidate matching block group to perform fusion prediction, the prediction accuracy may be improved, and the bit rate may be saved, meanwhile the encoding/decoding efficiency may also be improved, thereby improving the encoding/decoding performance. Further, by limiting the range of the index value of the candidate matching block group, the codeword for coding the index value is saved, and the coding efficiency is improved. For example, the index value is controlled to a smaller index range by reordering the candidate matching block groups.

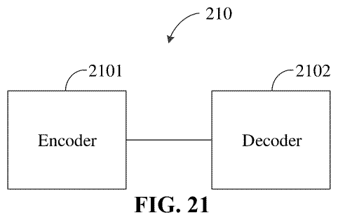

In another embodiment of the present disclosure, referring to FIG. 21, FIG. 21 illustrates a schematic diagram of a configuration structure of a codec system according to an embodiment of the present disclosure. As illustrated in FIG. 21, the codec system 210 may include an encoder 2101 and a decoder 2102.

In the embodiments of the present disclosure, the encoder 2101 may be an encoder described in any one of the aforementioned embodiments, and the decoder 2102 may be a decoder described in any one of the aforementioned embodiments.

It is to be noted that the terms used herein “including”, “comprising” or any other variation thereof are intended to encompass non-exclusive inclusion, so that a process, a method, an article or a device that includes a set of elements includes not only those elements but also other elements that are not explicitly listed, or also elements inherent to such a process, method, article or device. In the absence of further limitations, an element defined by the phrase “includes an . . . ” does not exclude the existence of another identical element in the process, method, article or device in which the elements are included.

The above serial numbers of the embodiments of the present disclosure are for description only and do not represent the advantages and disadvantages of the embodiments.

The features disclosed in several embodiments of the product provided in the disclosure can be arbitrarily combined as long as there is no conflict therebetween to obtain a new embodiment of a product.

The features disclosed in several embodiments of the product provided in the disclosure can be arbitrarily combined as long as there is no conflict therebetween to obtain a new embodiment of a product.

The features disclosed in several embodiments of methods or devices provided in the disclosure can be arbitrarily combined as long as there is no conflict therebetween to obtain a new embodiment of a method or a device.

The descriptions above are only the specific embodiments of the present disclosure, and are not intended to limit the scope of protection of the embodiments of the present disclosure. Any change and replacement are easily thought within the technical scope of the embodiments of the present by those skilled in the art, and fall with the protection scope of the present disclosure. Therefore, the scope of protection of the embodiments of the present disclosure shall be subject to the scope of protection of the claims.

### INDUSTRIAL PRACTICALITY

The embodiments of the present disclosure provide an encoding method, a decoding method, a bitstream, an encoder, a decoder, and a storage medium. It is determined that the current block is predicted by using the IntraTMP fusion intra prediction mode according to the relevant syntax element. A matching block for the current block is determined based on a template matching prediction mode, and a first prediction block for the current block is determined according to the matching block. A second prediction block for the current block is determined based on a non-template matching intra prediction mode. The first prediction block and the second prediction block are fused to determine a final prediction block for the current block. In this way, the relevant syntax element is encoded and decoded to determine whether the current block is predicted by using the IntraTMP fusion intra prediction mode, thereby improving the prediction efficiency. Meanwhile the IntraTMP fusion intra prediction mode combines IntraTMP technologies such as IntraTMP multi-candidate, IntraTMP multi-matching block fusion and IntraTMP filtering to adapt to more encoding/decoding scenarios, thereby ensuring prediction accuracy and the efficiency of encoding/decoding.

1. A method for decoding, applied to a decoder, comprising:
decoding a relevant syntax element of a current block, the relevant syntax element being used for indicating whether the current block is predicted by using an intra template matching prediction (IntraTMP) fusion intra prediction mode;
determining that the current block is predicted by using the IntraTMP fusion intra prediction mode according to the relevant syntax element;
determining a matching block for the current block based on a template matching prediction mode, and determining a first prediction block for the current block according to the matching block;
determining a second prediction block for the current block based on a non-template matching intra prediction mode; and
fusing the first prediction block and the second prediction block to determine a final prediction block for the current block.

2. The method of claim 1, wherein
the relevant syntax element comprises at least one of: a first syntax element or a second syntax element,
the first syntax element is used for indicating whether the IntraTMP fusion intra prediction mode is allowed to be used for predicting the current block; and
the second syntax element is used for indicating whether the current block is predicted by using the IntraTMP fusion intra prediction mode.

3. The method of claim 2, wherein decoding the relevant syntax element of the current block comprises:
decoding the first syntax element;
when a value of the first syntax element is a first value, determining that the IntraTMP fusion intra prediction mode is allowed to be used for predicting the current block, and decoding the second syntax element;
when a value of the second syntax element is a first value, determining that the current block is predicted by using the IntraTMP fusion intra prediction mode; and
when the value of the second syntax element is a second value, determining that the current block is predicted by using an IntraTMP multi-matching block fusion prediction mode.

4. The method of claim 2, wherein decoding the relevant syntax element of the current block comprises:
when a value of the first syntax element is a first value, determining that the current block is predicted by using an IntraTMP multi-matching block fusion prediction mode;
when the value of the first syntax element is a second value, determining that the IntraTMP fusion intra prediction mode is allowed to be used for predicting the current block, and decoding the second syntax element;
when a value of the second syntax element is a first value, determining that the current block is predicted by using the IntraTMP fusion intra prediction mode; and
when the value of the second syntax element is a second value, determining that the current block is predicted by using an IntraTMP multi-candidate prediction mode.

5. The method of claim 3, wherein the relevant syntax element further comprises a third syntax element; and the method further comprises:
decoding the third syntax element, wherein the third syntax element is used for indicating whether to filter a first matching block or whether to filter a prediction block for the current block.

6. The method of claim 5, wherein determining that the current block is predicted by using the IntraTMP fusion intra prediction mode comprises:
determining not to filter the first matching block or not to filter the prediction block for the current block according to a value of the third syntax element, and decoding the second syntax element; and
when the value of the second syntax element is the first value, determining that the current block is predicted by using the IntraTMP fusion intra prediction mode.

7. The method of claim 4, further comprising:
determining that the current block is predicted by using the IntraTMP multi-candidate prediction mode, and decoding a third syntax element, wherein the third syntax element is used for indicating whether to filter a first matching block.

8. The method of claim 5, wherein when it is determined to filter the first matching block, the method further comprises:
determining a filter coefficient for a matching block according to a template of the first matching block and a template of the current block; and
filtering the first matching block according to the filter coefficient for the matching block to obtain the first prediction block;
or
when it is determined to filter the prediction block for the current block, the method further comprises:
determining a filter coefficient for a prediction block according to a prediction template of the current block and the template of the current block; and
filtering the prediction block for the current block according to the filter coefficient for the prediction block, to obtain the final prediction block for the current block.

9. The method of claim 2, wherein the relevant syntax element further comprises a fourth syntax element; and the method further comprises:
decoding the fourth syntax element,
wherein the fourth syntax element is used for indicating an index value of a first matching block in a list of candidate matching blocks; or the fourth syntax element is used for indicating an index value of a first candidate matching block group in the list of candidate matching blocks.

10. The method of claim 2, further comprising:
determining that the current block is predicted by using the IntraTMP fusion intra prediction mode, and decoding the fourth syntax element; and
determining an index value of a first matching block in a list of candidate matching blocks according to the fourth syntax element;
or
determining that the current block is predicted by using the IntraTMP multi-matching block fusion prediction mode, and decoding a fifth syntax element; and
determining an index value of a first candidate matching block group in the list of candidate matching blocks according to the fifth syntax element.

11. A method for encoding, applied to an encoder, comprising:
determining a matching block for a current block based on a template matching prediction mode, and determining a first prediction block for the current block according to the matching block;
determining a second prediction block for the current block based on a non-template matching intra prediction mode;
fusing the first prediction block and the second prediction block to determine a final prediction block for the current block;
determining whether the current block is predicted by using an intra template matching prediction (IntraTMP) fusion intra prediction mode by performing coding determination according to the final prediction block for the current block and an original block for the current block; and
encoding a relevant syntax element of the current block, and signalling obtained encoded bits in a bitstream,
wherein the relevant syntax element is used for indicating whether the current block is predicted by using the IntraTMP fusion intra prediction mode.

12. The method of claim 11, wherein
the relevant syntax element comprises at least one of: a first syntax element or a second syntax element,
the first syntax element is used for indicating whether the IntraTMP fusion intra prediction mode is allowed to be used for predicting the current block; and
the second syntax element is used for indicating whether the current block is predicted by using the IntraTMP fusion intra prediction mode.

13. The method of claim 12, further comprising:
determining that the current block is predicted by using the IntraTMP fusion intra prediction mode, and encoding a fourth syntax element; and
determining an index value of a first matching block in a list of candidate matching blocks according to the fourth syntax element;
or
determining that the current block is predicted by using an IntraTMP multi-candidate prediction mode, and encoding a sixth syntax element; and
determining the index value of the first matching block in the list of candidate matching blocks according to the sixth syntax element.

14. The method of claim 12, further comprising:
determining that the current block is predicted by using the IntraTMP fusion intra prediction mode and encoding a seventh syntax element,
wherein the seventh syntax element is used for indicating the non-template matching intra prediction mode.

15. The method of claim 14, wherein the intra prediction mode comprises one of: a predefined intra prediction mode, an intra prediction mode of a matching block, an intra prediction mode derived based on Template-Based Intra Mode Derivation (TIMD), or an intra prediction mode derived based on Decoder-side Intra Mode Derivation (DIMD).

16. The method of claim 12, wherein the relevant syntax element comprises a first syntax element, when a value of the first syntax element is a first value, it is determined that the IntraTMP fusion intra prediction mode is allowed to be used for predicting the current block, and the method further comprises:
determining a first prediction template of the current block by predicting in a template region of the current block by using the IntraTMP fusion intra prediction mode;
determining a first template error value according to the first prediction template and a template of the current block;
determining a second prediction template of the current block by predicting in the template region of the current block by using a first IntraTMP prediction mode;
determining a second template error value according to the second prediction template and the template of the current block;
when a minimum template error value is the first template error value, determining that the current block is predicted by using the IntraTMP fusion intra prediction mode; and
when the minimum template error value is the second template error value, determining that the current block is predicted by using the first IntraTMP prediction mode,
wherein the first IntraTMP prediction mode comprises at least one of an IntraTMP multi-matching block fusion prediction mode or an IntraTMP multi-candidate prediction mode.

17. The method of claim 12, further comprising:
encoding an eighth syntax element, wherein the eighth syntax element is used for indicating whether to encode part or all of syntax elements in the relevant syntax element of the current block.

18. The method of claim 17, wherein the eighth syntax element comprises at least one of: a sequence-level syntax element, a picture-level syntax element, a tile-level syntax element, a slice-level syntax element, or a block-level syntax element.

19. The method of claim 12, wherein when it is determined that the current block is predicted by using the IntraTMP multi-matching block fusion prediction mode, the method comprises:
constructing a first list of candidate matching blocks for the current block based on template matching;
determining a first candidate matching block group from the first list of candidate matching blocks; and
fusing at least one matching block in the first candidate matching block group to determine a prediction block for the current block.

20. A non-transitory computer-readable storage medium having stored thereon a computer program and a bitstream, the computer program, when executed by a processor, enables the possessor to implement the following operations to generate the bitstream:
determining a matching block for a current block based on a template matching prediction mode, and determining a first prediction block for the current block according to the matching block;
determining a second prediction block for the current block based on a non-template matching intra prediction mode;
fusing the first prediction block and the second prediction block to determine a final prediction block for the current block;
determining whether the current block is predicted by using an intra template matching prediction (IntraTMP) fusion intra prediction mode by performing coding determination according to the final prediction block for the current block and an original block for the current block; and
encoding a relevant syntax element of the current block, and signalling obtained encoded bits in the bitstream,
wherein the relevant syntax element is used for indicating whether the current block is predicted by using the IntraTMP fusion intra prediction mode.
